(19) United States
(12) Patent Application Publication
(10) Pub. No.: US 2023/0125516 A1
(43) Pub. Date: Apr. 27, 2023

(54) METHOD FOR PRODUCING SURFACE-TREATED SILICA POWDER, RESIN COMPOSITION, AND SLURRY

(71) Applicant: TOKUYAMA CORPORATION, Yamaguchi (JP)

(72) Inventors: Go HAMASAKA, Yamaguchi (JP); Keiji SAIKI, Yamaguchi (JP); Hao HU, Yamaguchi (JP)

(21) Appl. No.: 17/912,426

(22) PCT Filed: Apr. 12, 2021
(86) PCT No.: PCT/JP2021/015132

§ 371 Date: Sep. 16, 2022

(30) Foreign Application Priority Data
Apr. 24, 2020 (JP) 2020-077244
Dec. 21, 2020 (JP) 2020-211602

(51) Int. Cl. C09C 1/30; C08K 9/06; C08K 3/36

(52) U.S. Cl. CPC C09C 1/3081; C08K 9/06; C08K 3/36

(57) ABSTRACT

Provided is a method for producing surface-treated silica powder that has excellent gap permeability and that allows a resin composition to have low viscosity in a case where the surface-treated silica powder is used as a resin filler, for example, for a semiconductor sealant. A surface treatment agent is brought into contact with silica powder such that: (1) a cumulative 50 mass % diameter D₅₀ of a mass-based particle size distribution obtained by a centrifugal sedimentation method is 300 nm to 500 nm (preferably 330 nm to 400 nm); (2) a loose bulk density is 250 kg/m³ to 400 kg/m³ (preferably 270 kg/m³ to 350 kg/m³); and (3) {(D₉₀−D₅₀)/D₅₀}×100 is 30% to 45% (preferably 33% to 42%), to modify the surface of the silica powder, so that surface-treated silica powder is produced.

### TECHNICAL FIELD

The present invention relates to a method for producing novel surface-treated silica powder that can be suitably used as fillers, for example, for a semiconductor sealant, for a liquid crystal sealant, and for a film. Specifically, the present invention relates to a method for producing surface-treated silica powder that has a controlled particle diameter and a controlled particle size distribution and thus has an excellent filling property.

### BACKGROUND ART

In recent years, with the miniaturization and thickness reduction of semiconductor devices for the purpose of higher degrees of integration and higher mounting densities, fillers added to a semiconductor sealant and a semiconductor mounting adhesive, which are typified by an epoxy resin composition, tend to have smaller particle diameters. Conventionally, amorphous silica powder having a BET specific surface area of not less than 5 m²/g and not more than 20 m²/g and a particle diameter of about not less than 100 nm and not more than 600 nm in terms of primary particle diameter has been used as the fillers.

However, the existing amorphous silica powder having the above-described BET specific surface area, due to generally having a high degree of aggregation property, has poor dispersibility and consequently has a large dispersed particle diameter and further has a broad particle size distribution at the time of dispersion. It has been found that a resin composition using such amorphous silica powder includes coarse particles derived from a filler and thus leads to poor penetration, which is insufficient penetration of the resin into gaps during molding.

To solve the poor penetration into the gaps, there has been proposed hydrophilic dry silica powder that, in spite of having the BET specific surface area in a range of not less than 5 m²/g and not more than 20 m²/g, which is the same as the range of the BET specific surface area of the conventional silica powder, has an extremely low aggregation property, has excellent dispersibility, has a small dispersed particle diameter, and has a narrow particle size distribution at the time of dispersion (Patent Literature 1). Further, the silica powder described in Patent Literature 2 has also been proposed.

Meanwhile, there has been made the proposal that surface-treating silica powder having high aggregation property can improve the dispersibility of the silica powder into a resin (Patent Literature 3).

### CITATION LIST

### Patent Literatures

[Patent Literature 1]
Japanese Patent Application Publication Tokukai No. 2014-152048

[Patent Literature 2]
Japanese Patent Application Publication Tokukai No. 2017-119621

[Patent Literature 3]
Japanese Patent Application Publication Tokukai No. 2014-201461

### SUMMARY OF INVENTION

### Technical Problem

Unfortunately, the silica powder described in Patent Literature 1 has the following problem. That is, the silica powder described in Patent Literature 1 has an enhanced permeability of the resin into the gaps, but has a small dispersed particle diameter. This induces the effect of increasing the viscosity of a resin composition. Consequently, a resin composition which is filled with the silica powder described in Patent Literature 1 has high viscosity.

On the other hand, Patent Literature 2 has proposed silica powder that, in spite of having the BET specific surface area of not less than 5 m²/g and not more than 20 m²/g, has a particle diameter which keeps the viscosity low at the time of dispersion, do not contain coarse particles which hinder penetration into gaps, and has unique dispersibility. Due to this unique dispersibility, it has been shown that a resin composition to which the silica powder described in Patent Literature 2 was added as a filler exhibits excellent performance in terms of both viscometric property and the gap permeability. However, there has been desired further performance improvement in terms of the viscometric property and the gap permeability to adapt to the demand for narrowing of gaps.

In order to solve the above problems, the inventors of the present invention have diligently studied, regarding silica obtained by burning a silicon compound in a flame, for example, the growth of silica particles and the aggregation of the particles in a flame and in the vicinity of the flame, by changing a burner, a reactor in which the burner is installed, flame conditions, and others. As a result, silica powder having excellent filling property, which achieves the above object, that is, silica powder satisfying all of the following conditions (1) to (3), obtained by adjusting the flame conditions, has already been proposed (PCT/JP2020/005618).

(1) A cumulative 50% mass diameter D50 of a mass-based particle size distribution obtained by a centrifugal sedimentation method is not less than 300 nm and not more than 500 nm.

(2) A loose bulk density is not less than 250 kg/m³ and not more than 400 kg/m³.

(3) {(D₉₀−D₅₀)/D₅₀}×100 is not less than 30% and not more than 45%, wherein D₉₀ is a cumulative 90 mass % diameter of the mass-based particle size distribution obtained by the centrifugal sedimentation method.

However, even silica having such properties has been required to have further improved properties such as a resin filling property.

Meanwhile, Patent Literature 3 and the like enable improvement in the dispersibility into a resin by subjecting silica to surface treatment silica, but still fail to provide sufficient viscometric property at the time of kneading into the resin. Thus, there has been a demand for further improvement in the viscometric property.

Therefore, it is an object of the present invention to provide a method for producing silica powder that has excellent filling property. More specifically, it is an object of the present invention to provide a method for producing surface-treated silica powder that, when used as a resin filler, allows for obtaining a resin composition having excellent gap permeability and low viscosity.

### Solution to Problem

The inventors of the present invention conducted diligent studies to attain the above object and found that further surface-treating the silica powder having the specific particle diameter and particle size distribution provides silica powder having more excellent filling property with respect to the resin and allowing an obtained resin kneaded product to have low viscosity and excellent gap permeability. As a result, the inventors of the present invention completed the present invention.

That is, the present invention is a method for producing surface-treated silica powder by which to surface-treat silica powder that satisfies all of the following conditions (1) to (3):

(1) A cumulative 50% mass diameter D50 of a mass-based particle size distribution obtained by a centrifugal sedimentation method is not less than 300 nm and not more than 500 nm.

(2) A loose bulk density is not less than 250 kg/m³ and not more than 400 kg/m³.

(3) {(D₉₀−D₅₀)/D₅₀}×100 is not less than 30% and not more than 45%, wherein D₉₀ is a cumulative 90 mass % diameter of the mass-based particle size distribution obtained by the centrifugal sedimentation method.

### Advantageous Effects of Invention

The surface-treated silica powder produced in accordance with the present invention has a controlled particle diameter and a controlled particle size distribution and also has a surface modified by a surface treatment agent. Therefore, a resin composition to which the surface-treated silica powder is added can achieve both excellent viscometric property and excellent gap permeability. Therefore, the silica powder produced in accordance with the present invention is suitable as a filler for a semiconductor sealant and for a semiconductor mounting adhesive. Particularly, the silica powder produced in accordance with the present invention can be suitably used as a filler for a high-density mounting resin.

### BRIEF DESCRIPTION OF DRAWINGS

FIG. 1 is a schematic diagram of a main part of a reaction apparatus used at the production of base silica powder that serves as a raw material.

### DESCRIPTION OF EMBODIMENTS

A method for producing surface-treated silica powder in accordance with the present invention will be described in detail below in accordance with embodiments of the present invention.

In the present invention, silica powder that serves as a base material before surface treatment (hereinafter also referred to as “base silica powder”) is silica powder obtained by a silica powder production method in which silica powder is formed by burning a silicon compound and is grown and aggregated in a flame and in the vicinity of the flame, a so-called “dry method (also referred to as a combustion method, etc.)”, and has the following properties:

(1) A cumulative 50% mass diameter D50 of a mass-based particle size distribution obtained by a centrifugal sedimentation method is not less than 300 nm and not more than 500 nm.

(2) A loose bulk density is not less than 250 kg/m³ and not more than 400 kg/m³.

(3) {(D₉₀−D₅₀)/D₅₀}×100 is not less than 30% and not more than 45%, wherein D₉₀ is a cumulative 90 mass % diameter of the mass-based particle size distribution obtained by the centrifugal sedimentation method.

In a case where the cumulative 50% mass diameter D50 (hereinafter also referred to as “median diameter D₅₀”) of the mass-based particle size distribution obtained by the centrifugal sedimentation method exceeds 500 nm, a resin composition using surface-treated silica, in spite of having low viscosity, has an excessively large silica particle diameter in relation to the gap. This results in voids generated during gap permeation and causes a molding defect. That is, sufficient narrow gap permeability cannot be obtained. On the other hand, a particle diameter of less than 300 nm is not preferable because it results in a resin composition having high viscosity. More preferably, the particle size is not less than 330 nm and not more than 400 nm.

The property of base silica powder is specified by the loose bulk density of not less than 250 kg/m³ and not more than 400 kg/m³. Here, the loose bulk density is a filling density obtained when the silica powder is naturally dropped into a cup having a predetermined capacity. The loose bulk density of less than 250 kg/m³ is not preferable because it causes low filling property even though a surface treatment has been performed, and thus results in a resin composition having high viscosity.

In a case where the loose bulk density exceeds 400 kg/m³, a resin composition using surface-treated silica, in spite of having low viscosity, has an excessively large silica particle diameter in relation to the gap. This results in voids generated during gap permeation and causes a molding defect. That is, sufficient narrow gap permeability cannot be obtained. Preferably, the loose bulk density is not less than 270 kg/m³ and not more than 350 kg/m³.

The property such that the particle size distribution is appropriately adjusted is specified by a relation between the cumulative 50% mass diameter D₅₀ and the cumulative 90% mass diameter D₉₀ being such that {(D₉₀−D₅₀)/D₅₀}×100 is not less than 30% and not more than 45%. The particle size distribution expressed by the above-described formula exceeding 45% indicates the presence of many coarse particles, and thus increases coarse particles even in surface-treated silica and causes voids. On the other hand, the particle size distribution of less than 30%, which is a narrow particle size distribution, is not preferable because it decreases a bulk density value and thus does not achieve low viscosity. More preferably, {(D₉₀−D₅₀)/D₅₀}×100 is not less than 33% and not more than 42%.

Further, the base silica powder in the present invention preferably has a geometric standard deviation σ_{g} of the mass-based particle size distribution obtained by the centrifugal sedimentation method in a range of not less than 1.25 and not more than 1.40. It can be said that a small geometric standard deviation σ_{g} shows a narrow particle size distribution, and thus it can be said that the amount of coarse particles is decreased. However, the presence of a particle size distribution in a certain range is likely to decrease the viscosity obtained when the silica powder is added to a resin.

The geometric standard deviation σ_{g} is a geometric standard deviation calculated by fitting a lognormal distribution (least squares method) to the mass-based particle size distribution obtained by the centrifugal sedimentation method in a range of a cumulative frequency of not less than 10 wt % and not more than 90 wt %.

The mass-based particle size distribution by the centrifugal sedimentation method is a mass-based particle size distribution of dispersed particles obtained by dispersing the silica powder in water at a concentration of 1.5 wt % at an output of 20 W and for a treatment time of 15 minutes.

The base silica powder in the present invention is preferably such that element contents of iron, nickel, chromium, and aluminum are each less than 1 ppm. This enables reduction of short circuits between metal lines in a semiconductor device.

Further, the base silica powder in the present invention is preferably such that ion contents of sodium ions, potassium ions, and chloride ions which are measured by a hot water extraction method are each less than 1 ppm. This enables reduction of malfunction of the semiconductor device and reduction of corrosion of the metal lines in the semiconductor device.

Further, it is preferable that the particles constituting the base silica powder in the present invention are shaped in a sphere. Such a shape can be grasped by, for example, electron microscope observation.

The base silica powder in the present invention is preferably such that a water suspension containing the silica powder at 0.075 wt % has an optical absorbance τ₇₀₀ for light of a wavelength of 700 nm is not more than 0.60. A small value of the optical absorbance τ₇₀₀ indicates good dispersibility, thus indicates a small dispersed particle diameter, and further indicates a narrow particle size distribution at the time of dispersion and a small number of coarse particles. Thus, at the time of being subjected to surface treatment, the base silica powder in the present invention is dispersed well into a solvent during wet surface treatment, which will be described later, and is therefore more likely to be uniformly surface-treated.

Since the base silica powder in the present invention has a median diameter D₅₀ and the like as described above, the specific surface area usually measured by the Brunauer-Emmett-Teller (BET) one-point method is about not less than 6 m²/g and not more than 14 m²/g.

The base silica powder having the physical properties as described above is obtained, in a dry silica production method in which silica powder is formed by burning a silicon compound and is obtained by being grown and aggregated in a flame and in the vicinity of the flame, by installing a burner having a concentric multiple pipe structure of three or more pipes in a reactor which has a cooling jacket portion provided around the burner, and adjusting flame combustion conditions and cooling conditions. That is, silica powder that serves as a base material can be efficiently produced by controlling the flame combustion conditions so that the amount of oxygen in the entire flame is increased, and by controlling the cooling conditions so that a cooling rate of the flame is slowed down.

The following will describe specific examples including a method for controlling flame combustion conditions and cooling conditions.

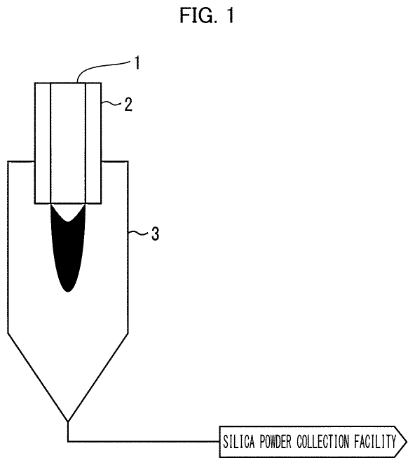

FIG. 1 is a schematic diagram of an apparatus for producing base silica powder. In the apparatus illustrated in FIG. 1, the circumference of a burner 1 having a concentric triple pipe structure is surrounded by a tubular external cylinder 2. If the tubular external cylinder 2 is regarded as the fourth pipe of the burner 1, the burner 1 as a whole can also be regarded as having a quadruple pipe structure. Hereinafter, the pipes constituting the concentric triple pipe will be referred to as a “central pipe”, a “first annular pipe”, and a “second annular pipe” in the order from the central portion to the outer edge.

The burner 1 is installed in a reactor 3 in which a flame is burned inside the reactor 3 and silica is thus formed from a silicon compound inside the reactor 3. The reactor 3 has a structure such that a jacket portion (not illustrated) is provided outside the reactor 3 to allow a refrigerant to flow therein so that the reactor 3 is subjected to forced cooling.

In the above-described apparatus, a silicon compound in a gaseous state and oxygen are mixed in advance and introduced into the central pipe of the above-described triple pipe. At this time, an inert gas such as nitrogen may also be mixed together. In a case where the silicon compound is liquid or solid at room temperature, the silicon compound is heated to be vaporized before use. Further, in a case where silica is formed by hydrolysis reaction of the silicon compound, a fuel that generate water vapor when reacted with oxygen, such as a combination of, for example, hydrogen and a hydrocarbon, is mixed together.

Further, a fuel for forming an auxiliary flame (for example, hydrogen and a hydrocarbon) is introduced into the first annular pipe which is adjacent to the central pipe of the triple pipe. At this time, an inert gas such as nitrogen may be mixed and introduced. Further, oxygen may also be mixed together.

Further, oxygen is introduced into the second annular pipe which is provided outside the first annular pipe in the triple pipe so as to be adjacent thereto. The oxygen has the following two roles: silica formation by reaction with a silicon compound; and auxiliary flame formation. At this time, an inert gas such as nitrogen may be mixed together.

Further, a mixed gas formed of oxygen and an inert gas such as nitrogen is introduced into a space defined by an outer wall of the triple pipe and an inner wall of the tubular external cylinder 2. Using air as the mixed gas is easy and is thus a preferable form.

As described above, the jacket portion is provided outside the reactor 3 to circulate a refrigerant for removing combustion heat out of the system. In most cases, the combustion gas contains water vapor. Thus, to prevent the condensation of water vapor and the subsequent corrosion of the reactor 3 caused by absorption of corrosive components in the combustion gas by condensed water, it is a preferable mode that a refrigerant temperature before combustion heat absorption (specifically, a temperature at which the refrigerant is introduced into the jacket) is not lower than 50° C. and not higher than 200° C. Considering the ease of implementation, it is a more preferable mode that hot water having a temperature of not lower than 50° C. and not higher than 90° C. is used as the refrigerant. A difference between the temperature at which the refrigerant is introduced into the jacket portion (inlet temperature) and the temperature of the refrigerant discharged from the jacket portion (outlet temperature) is calculated. Then, from the calculated temperature difference, a specific heat of the refrigerant, and the amount of the refrigerant flown, the amount of heat absorbed by the refrigerant, that is, the amount of heat removed by the refrigerant from the reactor 3 can be grasped.

To obtain the base silica powder having the above-described physical properties, adjusting the flame combustion conditions and cooling conditions is important as described below, and it is preferable to satisfy the following conditions.

R_{cmbts}≥0.5 (A)

wherein R_{cmbts} is the amount of oxygen introduced into the second annular pipe (mol/h)/{16×the amount of raw material gas introduced into the central pipe (mol/h)}

N_{G3}/M_{Si}≤1.0 (B)

wherein N_{G3} is the amount of gas introduced into the third annular pipe (Nm³/h), and M_{Si} is a mass of silica to be formed (kg/h).

Furthermore, in a case where R_{cmbts} is less than 0.5, which indicates a small amount of oxygen in an entire flame, the reaction does not proceed completely, and a growth time of particles is thus shortened. As a result, fine particles having a particle diameter of several tens of nanometers are generated, the median diameter D₅₀ decreases, and a value of the loose bulk density decreases.

In a case where the above-described N_{G3}/M_{Si} exceeds 1.0, a flame is rapidly cooled, and as a result, fine particles having a particle diameter of several tens of nanometers are generated, and a molten silica melt has an increased region where the viscosity is high. This makes the fine particles difficult to change their shapes (This makes the fine particles difficult to grow and develops a strong tendency for the fine particles to remain small in particle diameter). Therefore, the median diameter D₅₀ falls below 300 nm.

As the silicon compound which is a raw material, compounds that are gas, liquid, or solid at room temperature are used without particular limitation. For example, cyclic siloxanes such as octamethylcyclotetrasiloxane, chain siloxanes such as hexamethyldisiloxane, alkoxysilanes such as tetramethoxysilane, and chlorosilanes such as tetrachlorosilane can be used as the silicon compound.

It is preferable to use a silicon compound that does not contain chlorine in the molecular formula, such as the above-mentioned siloxanes and alkoxysilanes, because chloride ions contained in obtained silica powder can be significantly reduced.

Further, as the silicon compound, a compound having a low content of various metal impurities can be easily obtained. Thus, by using such a silicon compound having a low content of metal impurities as a raw material, the amount of metal impurities contained in the formed silica powder can be reduced. Further, by further purifying the silicon compound by distillation or the like and using the purified silicon compound as a raw material, the amount of metal impurities contained in the formed silica powder can be further reduced.

The collection of the formed silica powder is not particularly limited. However, the collection of the formed silica powder is performed by separating the silica powder from a combustion gas by filter separation using a sintered metal filter, a ceramic filter, a back filter, or the like filter, or by centrifugation using a cyclone or the like and collecting the silica powder.

In the above description, the concentric triple pipe used is one concentric triple pipe. However, as shown in Examples described later, the method may be carried out in a multiple-pipe system in which a plurality of concentric triple pipes are arranged. In the case of the multiple-pipe system, it is preferable that each concentric triple pipe has the same structure and the same dimensions, and distances between the nearest centers of the concentric triple pipes are identical to each other, in terms of uniformity in obtaining the silica powder of the present invention. Further, the tubular external cylinder 2 may be installed so as to cover a plurality of concentric triple pipe burners together.

As is well known, in the method for producing silica powder by burning a silicon compound, liquid-form silica melted in the flame is spheroidized by surface tension. Accordingly, particles of solid silica powder to be produced are shaped in sphere close to true sphere. Further, since the particles of the silica powder produced by the above method substantially do not contain internal bubbles, the true density is substantially the same as the theoretical density of 2.2 g/cm³ of silica. Therefore, the silica powder produced by the above-mentioned method for producing silica powder that serves as a base material of the surface-treated silica powder in the present invention is also shaped in sphere and has a true density of about 2.2 g/cm³.

In the production method in accordance with an embodiment of the present invention, the base silica powder obtained as described above is brought into contact with a surface treatment agent to modify the surface of the silica powder, so that surface-treated silica powder is obtained.

In the present invention, the type of surface treatment reaction is not particularly limited, and a known method may be appropriately selected and employed. Either a so-called dry method or a so-called wet method may be employed, and further, either a batch type method or a continuous type method may be employed. Further, the reaction apparatus may be a fluidized-bed reaction apparatus or a fixed-bed reaction apparatus, or alternatively, may be a stirrer, a mixer, or a stationary reaction apparatus. In particular, in view of the uniformity and acceleration property of the reaction, a more preferable mode is such that silica powder is fluidized and reacted in a fluidized-bed reaction apparatus, a stirrer, a mixer, or the like.

Here, a state in which the silica powder surface is modified by the surface treatment agent refers to a state in which the surfaces of silica particles constituting powder, by treatment with the surface treatment agent, have, for example, surface shape, chemical composition, chemical reactivity, and dispersibility into a resin which have been changed by the functional groups and the like of the surface treatment agent. Suitably, the state in which the silica powder surface is modified by the surface treatment agent corresponds to a state in which introducing the surface treatment agent into the silica powder surface improves dispersibility into a resin and imparts water repellency. This improves dispersibility of silica powder into a resin, decreases viscosity of a resin composition, and further increases strength of the resin composition. Further, imparting water repellency to silica powder suppresses moisture adsorption during storage. This often produces the effect of improving storage stability and the like.

The degree of modification made by introducing carbon atoms to the surfaces of the silica particles can be evaluated typically by measuring the amount of carbons in the silica powder. The measurement of the amount of carbons may be carried out with use of a trace carbon analyzing device by a combustion oxidation method. Specifically, the amount of carbons in the silica powder is determined by heating a surface-treated silica powder sample to 1350° C. in an oxygen atmosphere and converting the amount of carbons obtained into an amount per unit mass. The surface-treated silica powder used for the measurement is subjected, as a pretreatment, to removal of water and the like adsorbed in the air therefrom through heating at 80° C. and pressure reduction in a system, and is then used for the measurement of the carbon content. In general, a surface treatment agent modifies only the surface of silica and does not modify the inside of silica without communication holes (the surface treatment agent cannot contact the inside of silica in the first place). Thus, the increased amount of carbons may be regarded as the surface carbon amount.

The surface carbon amount of the surface-treated silica powder produced in accordance with an embodiment of the present invention is preferably not less than 0.01% by mass and not more than 2% by mass, more preferably not less than 0.03% by mass and not more than 1% by mass, and particularly preferably not less than 0.03% by mass and not more than 0.8% by mass.

In the production method in accordance with an embodiment of the present invention, the surface treatment agent to be brought into contact with the base silica powder is not particularly limited, provided that it is a known surface treatment agent used to impart a specific function to the silica surface, but is preferably at least one surface treatment agent selected from silicone oil, a silane coupling agent, siloxanes, and silazanes. Particularly, the surface treatment agent is preferably at least one surface treatment agent selected from the group consisting of a silane coupling agent and silazanes.

It is desirable that a surface treatment agent having a functional group corresponding to modifying properties to be imparted to the obtained surface-treated silica powder be selected from among these surface treatment agents.

Specific examples of the surface treatment agent that can be used in the production method in accordance with an embodiment of the present invention includes, as the silicone oil, dimethyl silicone oil, methylphenyl silicone oil, methylhydrogen silicone oil, alkyl-modified silicone oil, amino-modified silicone oil, epoxy-modified silicone oil, carboxyl-modified silicone oil, carbinol-modified silicone oil, methacryl-modified silicone oil, polyether-modified silicone oil, and fluorine-modified silicone oil.

As the silane coupling agent, a known silane coupling agent is used as appropriate according to an intended use.

Examples of the silane coupling agent include those represented by the following formula (1):

Rₙ—Si—X₍₄₋ₙ₎ (1)

(In the above formula (1), R is an organic group having 1 to 12 carbon atoms, X is a hydrolyzable group, and n is an integer of 1 to 3.).

Examples of the organic group represented by “R” above and having 1 to 12 carbon atoms include: a hydrocarbon group having 1 to 12 carbon atoms such as a methyl group, an ethyl group, an n-propyl group, a hexyl group, an octyl group, a decyl group, a phenyl group, a vinyl group, an octenyl group, and a 4-styryl group; a fluorine-substituted hydrocarbon group having 1 to 12 carbon atoms such as a 3,3,3-trifluoropropyl group; an organic group having 3 to 12 carbon atoms and having an epoxy group such as a 3-glycidoxypropyl group, a 2-(3,4-epoxycyclohexyl) ethyl group, a glycidoxyoctyl group, and a glycidoxyoctyl group; an organic group having 1 to 12 carbon atoms and having an amino group such as a 3-aminopropyl group, an N-(2-aminoethyl)-3-aminopropyl group, an N-phenyl-3-aminopropyl group, an N-phenyl-3-aminopropyl group, an N,N-dimethyl-3-aminopropyl group, and an N,N-diethyl-3-aminopropyl group; an organic group having 3 to 12 carbon atoms and having a (meth)acryloxy group such as a 3-(meth)acryloxypropyl group and a (meth)acryloxyoctyl group; an organic group having 1 to 12 carbon atoms and having a mercapto group such as a 3-mercaptopropyl group; and an organic group having 3 to 12 carbon atoms and having an isocyanate group such as a 3-isocyanatepropyl group. Among those listed above, an organic group having 10 or less carbon atoms is preferable.

When n is 2 or 3, a plurality of Rs may be the same or different.

Examples of the X include an alkoxy group having 1 to 3 carbon atoms such as a methoxy group, an ethoxy group, and a propoxy group, and a halogen atom such as a chlorine atom. Among those listed above, a methoxy group and an ethoxy group are preferable. Note that, in a case where n is 1 or 2, the plurality of Xs may be the same or different, but are preferably the same.

n is an integer of 1 to 3, but is preferably 1 or 2, and particularly preferably 1.

Among the silane coupling agents represented by the above formula (1), a silane coupling agent capable of introducing a hydrocarbon group having 1 to 10 carbon atoms into the silica surface, that is, a silane coupling agent in which R is a hydrocarbon group having 1 to 10 carbon atoms in the above formula (1) is preferably used, in order to increase the dispersibility into the inside of the resin and decrease the viscosity. Specific examples of the silane coupling agent include methyltrimethoxysilane, methyltriethoxysilane, dimethyldimethoxysilane, dimethyldiethoxysilane, n-propyltrimethoxysilane, n-propyltriethoxysilane, hexyltrimethoxysilane, hexyltriethoxysilane, octyltrimethoxysilane, octyltriethoxysilane, decyltrimethoxysilane, decyltriethoxysilane, phenyltrimethoxysilane, phenyltriethoxysilane, vinyltrimethoxysilane, vinyltriethoxysilane, and 4-styryltrimethoxysilane.

Among those listed above, a silane coupling agent in which R is a hydrocarbon group having 1 to 8 carbon atoms is more preferable, and specifically, n-propyltrimethoxysilane, n-propyltriethoxysilane, hexyltrimethoxysilane, hexyltriethoxysilane, octyltrimethoxysilane, octyltriethoxysilane, phenyltrimethoxysilane, and phenyltriethoxysilane are more preferable. A silane coupling agent in which R is an aromatic hydrocarbon group having 6 to 8 carbon atoms is particularly preferable, and specific examples of such a silane coupling agent include phenyltrimethoxysilane.

Further, in a case where an epoxy resin generally used, for example, for electronic materials such as a semiconductor sealant and a liquid crystal sealant and for film production is used as a matrix, a silane coupling agent capable of introducing an epoxy group or an amino group into the silica surface, that is, a silane coupling agent in which at least one R is an organic group having 3 to 12 carbon atoms and having an epoxy group or an organic group having 1 to 12 carbon atoms and having an amino group, among the silane coupling agents represented by the above formula (1) is preferably used because such a silane coupling agent can be firmly bonded to the resin when the resin is cured.

Specific examples of such a silane coupling agent include: a silane coupling agent having an organic group that has 3 to 12 carbon atoms and has an epoxy group such as 3-glycidoxypropyltrimethoxysilane, 3-glycidoxypropyltriethoxysilane, 3-glycidoxypropylmethyldimethoxysilane, 3-glycidoxypropylmethyldiethoxysilane, 2-(3,4-epoxycyclohexyl)ethyltrimethoxysilane, and glycidoxyoctyltrimethoxysilane; and a silane coupling agent having an organic group that has 1 to 12 carbon atoms and has an amino group such as 3-aminopropyltrimethoxysilane, 3-aminopropyltriethoxysilane, N-(2-aminoethyl)-3-aminopropyltrimethoxysilane, N-(2-aminoethyl)-3-aminopropylmethyldimethoxysilane, N-phenyl aminopropyltrimethoxysilane, N,N-dimethyl aminopropyltrimethoxysilane, and N,N-diethyl-3-aminopropyltrimethoxysilane.

A particularly preferable silane coupling agent is 3-glycidoxypropyltrimethoxysilane, 3-glycidoxypropyltriethoxysilane, glycidoxyoctyltrimethoxysilane, 3-aminopropyltrimethoxysilane, 3-aminopropyltriethoxysilane, N-(2-aminoethyl)-3-aminopropyltrimethoxysilane, N-(2-aminoethyl)-3-aminopropylmethyldimethoxysilane, and N-phenyl-3-aminopropyltrimethoxysilane.

Further, similarly, in a case where a (meth)acrylic resin generally used, for example, for electronic materials such as a semiconductor sealant and a liquid crystal sealant and for film production is used as a matrix, a silane coupling agent capable of introducing a group having a carbon-carbon double bond at a terminal thereof into the silica surface is preferably used because such a silane coupling agent can be firmly bonded to the resin when the resin is cured. That is, a silane coupling agent in which R is a hydrocarbon group having 2 to 12 carbon atoms and having a terminal double bond in the above formula (1) or a silane coupling agent in which R is an organic group having 3 to 12 carbon atoms and having a (meth)acryloyl group in the above formula (1) is preferably used.

Specific examples of such a silane coupling agent include: a silane coupling agent in which R is a hydrocarbon group having 2 to 12 carbon atoms and having a terminal double bond such as vinyltrimethoxysilane, vinyltriethoxysilane, and 4-styryltrimethoxysilane; and a silane coupling agent in which R is an organic group having 3 to 12 carbon atoms and having a (meth)acryloyl group such as 3-(meth)acryloxypropyltrimethoxysilane, 3-(meth)acryloxypropyltriethoxysilane, 3-(meth)acryloxypropylmethyldimethoxysilane, 3-(meth)acryloxypropylmethyldiethoxysilane, and (meth)acryloxyoctyltrimethoxysilane. A particularly preferable silane coupling agent is a silane coupling agent in which n is 1, and R is an organic group having a (meth)acryloyl group and having 6 to 12 carbon atoms, and is specifically, for example, 3-(meth)acryloxypropyltrimethoxysilane, 3-(meth)acryloxypropyltriethoxysilane, and (meth)acryloxyoctyltrimethoxysilane.

Examples of the siloxanes include polysiloxanes such as disiloxane, hexamethyldisiloxane, hexamethyldicyclotrisiloxane, octamethylcyclotetrasiloxane, decamethylcyclopentasiloxane, and polydimethylsiloxane.

As the silazanes, commonly used known compounds having a silicon-nitrogen (Si—N) bond can be used without any particular limitation. A compound to be used is selected as appropriate from among these compounds according to, for example, required performance of the surface-treated silica powder. Specific examples of the silazanes include hexamethyldisilazane, 1,3-divinyl-1,1,3,3-tetramethyldisilazane, octamethyltri, hexa(t-butyl)disilazane, hexabutyldisilazane, hexaoctyldisilazane, 1,3-diethyltetramethyldisilazane, 1,3-di-n-octyltetramethyldisilazane, 1,3-diphenyltetramethyldisilazane, 1,3-dimethyltetraphenyldisilazane, 1,3-diethyltetramethyldisilazane, 1,1,3,3-tetraphenyl-1,3-dimethyldisilazane, 1,3-dipropyltetramethyldisilazane, hexamethylcyclotrisilazane, hexaphenyldisilazane, dimethylaminotrimethylsilazane, trisilazane, cyclotrisilazane, and 1,1,3,3,5,5-hexamethylcyclotrisilazane.

Among these, alkyldisilazanes are preferable due to their high reactivity with a silica surface, tetramethyldisilazane, hexamethyldisilazane, and heptamethyldisilazane are particularly preferable, and hexamethyldisilazane is most preferable.

The following description will discuss a method of treating the base silica powder with use of the above-mentioned surface treatment agent (hereinafter also referred to simply as “surface treatment method”).

In the surface treatment method, the surface of the base silica powder is modified by bringing the base silica powder into contact with at least one surface treatment agent selected from the above-mentioned silicone oil, silane coupling agents, siloxanes, and silazanes.

The surface treatment method can be broadly classified into dry surface treatment and wet surface treatment. The dry surface treatment is a method in which the base silica powder is brought into contact with the surface treatment agent while the base silica powder maintains the powder state, and is a method suitable for mass production since the dry surface treatment does not use a large amount of solvent and is thus generally less costly. Meanwhile, the wet surface treatment is a method in which the base silica powder is dispersed in a solvent and is brought into contact with the surface treatment agent in a state in which the base silica powder is in the form of a dispersion liquid (including a paste), and has the advantage of allowing the silica surface to be more uniformly modified than the dry surface treatment. In the production method in accordance with an embodiment of the present invention, known methods can be employed as appropriate as these surface treatment methods, and any method may be employed. The following will describe typical procedures and the like in the individual methods.

### 1. Surface-Treated Silica Production Method by Dry Surface Treatment (First Embodiment)

In the dry surface treatment, surface treatment is generally carried out by the following procedure. That is, the base silica powder is placed in a reaction vessel, and a predetermined amount of the surface treatment agent is added by, for example, dropping or spraying in a state in which the base silica powder is fluidized by, for example, shaking or stirring. At this time, aging is usually carried out to promote the reaction of the surface treatment agent with the silica surface. Silica powder taken out of the vessel after the reaction with the surface treatment agent can be used as it is as a product. The following will describe the procedure (steps) in more detail.

<Surface Treatment Agent and Amount of Surface Treatment Agent Used>

As the surface treatment agent, at least one selected from the above-described silicone oil, silane coupling agents, siloxanes, and silazanes can be used.

The amount of surface treatment agent to be used is not particularly limited, and may be set as appropriate from known ranges according to desired physical properties. An excessively small amount of surface treatment agent results in insufficient surface treatment, and an excessively large amount of surface treatment agent causes an excessive amount of silicone oil to be present on the silica powder surface and thus accelerates the tendency to form agglomerates. Thus, in a case where the silicone oil is used as the surface treatment agent, the amount of the silicone oil is preferably 0.05 parts by mass to 80 parts by mass, more preferably 0.1 parts by mass to 60 parts by mass, and most preferably 1 part by mass to 20 parts by mass, relative to 100 parts by mass of the base silica powder.

Similarly, in a case where the silane coupling agent is used as the surface treatment agent, the amount of the silane coupling agent is preferably 0.05 parts by mass to 80 parts by mass, more preferably 0.1 parts by mass to 40 parts by mass, and most preferably 0.5 parts by mass to 5 parts by mass.

Similarly, in a case where the siloxane is used as the surface treatment agent, the amount of the siloxane is preferably 0.1 parts by mass to 150 parts by mass, more preferably 1 part by mass to 120 parts by mass, and most preferably 2 parts by mass to 60 parts by mass.

Similarly, in a case where the silazane is used as the surface treatment agent, the amount of the silazane is preferably 0.1 parts by mass to 150 parts by mass, more preferably 1 part by mass to 120 parts by mass, and most preferably 2 parts by mass to 60 parts by mass.

Only one type of the surface treatment agents may be used alone, or two or more types thereof may be used in combination.

<Dry Surface Treatment Apparatus>

In the present embodiment, the silica surface is treated by dry surface treatment by mixing the silica powder and various surface treatment agents. Means for mixing the silica powder and various surface treatment agents is not particularly limited, but is preferably mixing means that does not use a rotating body having a drive unit. Specific examples of the mixing means include mixing by rotation or swinging of a vessel body and vapor-phase mixing with use of air. Examples of a mixing apparatus having such mixing means include a V-blender, a rocking mixer, a double-cone mixing apparatus, and an air blender that performs air flow mixing with use of air.

Meanwhile, in a case where mixing means that uses a rotating body having a drive unit is used, stirring energy that is applied to the silica powder when the silica powder collides with stirring blades or mixing blades is usually as high as 50 J or more, and aggregated particles are thus likely to be generated in powder with a relatively small particle diameter like the above-described base silica powder. Specific examples of such mixing means include a mixing apparatus having stirring blades, mixing blades, or the like, such as a Henschel mixing apparatus and a Loedige mixer.

The mixing apparatus (dry surface treatment apparatus) used in the present embodiment preferably has further at least one crushing blade as mean for making the particle diameters of the silica powder before and after surface treatment equal. The crushing blade, which is a rotating body that has a rotating shaft and that serves as crushing means, is at least one blade extending in a direction perpendicular to the rotating shaft that passes through the center of gravity of the blade or that is located at one end of the blade. In a case where a plurality of crushing blades are mounted on the same rotating shaft, the crushing blades may be mounted at any positions on the rotating shaft, provided that there is sufficient clearance between the crushing blades and the inner wall of a mixing vessel and between one crushing blade and the other crushing blade(s). The plurality of crushing blades may be mounted at one position or at a plurality of positions. In consideration of the capacity of the mixing apparatus, the amount of silica powder to be treated, and the crushing energy described below, it is preferable that one to four crushing blades be mounted to a single rotating shaft.

In the present embodiment, the crushing energy of the crushing blades is preferably 0.3 J to 10 J. In a case where the crushing energy is less than 0.1 J, aggregated particles remain without being sufficiently crushed. In a case where the crushing energy is higher than 20 J, the silica powder tends to be reaggregated. Here, the crushing energy is much smaller than the stirring energy, which is not less than 50 J, of the stirring blades or mixing blades used as the mixing means. Accordingly, the crushing blade in the present embodiment is clearly distinguished from a rotating body that has a drive unit and that is used as the mixing means. Namely, the crushing blade in the present embodiment is clearly distinguished from the stirring blades or mixing blades.

Examples of a method for calculating the crushing energy will be specifically described. The crushing energy is calculated for each rotating shaft. First, the moment of inertia of the crushing blade is determined.

(Case where the Rotating Shaft Passes Through the Center of Gravity of the Blade)

Assuming that a₁ (m) denotes the length of a longer side of the crushing blade which is perpendicular to the rotating shaft, b (m) denotes the length of a shorter side of the crushing blade, t (m) denotes the thickness of the crushing blade, M (kg) denotes the weight of the crushing blade, and m denotes the number of blades mounted on the same rotating shaft, the moment of inertia (Iz₁) of the blade such that the rotating shaft passes through the center of gravity of the blade is calculated by the following expression:

Iz₁ (kg·m²)=(a₁²+b₂)×M/12×m (C)

(Case where the Rotating Shaft is Located at One End of the Blade)

Assuming that a₂ (m) denotes the length of a longer side of the crushing blade which is perpendicular to the rotating shaft, b (m) denotes the length of a shorter side of the crushing blade, t (m) denotes the thickness of the crushing blade, M (kg) denotes the weight of the crushing blade, and n denotes the number of blades mounted on the same rotating shaft, the moment of inertia (Iz₂) of the blade such that the rotating shaft is located at one end of the blade is calculated by the following expression:

Iz₂ (kg·m²)=(a₂²+b²+12(a₂/2)²)×M/12×n (D)

(Case where there are Both a Blade with the Rotating Shaft Passing Through the Center of Gravity of the Blade and the Blade with the Rotating Shaft Located at One End of the Blade)

The moment of inertia (Iz₃) of the crushing blade is calculated by the following expression:

Iz₃ (kg·m²)=Iz₁+Iz₂ (E)

Next, with use of the moments of inertia calculated by the expressions (C), (D), and (E) and the rotation speed ω (rad/s) of the crushing blade, the crushing energy E (J) is calculated by the following expression:

Crushing energy E (J)=Iz×ω²/2 (F)

In a case where the mixing apparatus has a crushing blade having a shape other than the above-described shapes, the crushing energy can be calculated by a known expression according to the shape of the crushing blade.

In the mixing apparatus in accordance with the present embodiment, the crushing energy per rotating shaft need only be within the above-described range. The mixing apparatus in accordance with the present embodiment need only include at least one rotating shaft with a crushing blade. The mixing apparatus may have a plurality of rotating shafts. In this case, the crushing energy of the crushing blade of each rotating shaft is in the range of 0.3 J to 10 J.

The material of the rotating shaft and the crushing blade is not particularly limited. Specific examples of the material include metals, such as stainless steel, aluminum, and resins such as polycarbonate, polypropylene, and acryl resin. Among these, metals, stainless steel, in particular, are preferable since they have excellent abrasion resistance.

The shape of the crushing blade is not particularly limited, and a crushing blade having a known shape can be used. For example, horizontal, L-shaped, and cylindrical crushing blades can be used.

The size of the crushing blade is not particularly limited, provided that the crushing blade is accommodated in the mixing apparatus and that the crushing energy is within the above-described range. Even in a case where load from the material contained in the mixing apparatus is locally applied to the crushing blade during rotation of the crushing blade, the crushing blade need only be mounted with sufficient clearance to the wall surface or the other crushing blade(s) so that the crushing blade will not collide with the wall surface or the other crushing blade(s).

An excessively short length of the longer side of the crushing blade decreases a crushing effect (the crushing blade needs to rotate at a higher speed to obtain required crushing energy). An excessively longer length of the longer side of the crushing blade requires large power to rotate the crushing blade. The longer the length of the longer side of the crushing blade is, the higher the crushing energy becomes to an extent such that the crushing energy exceeds the above-described range. This makes the silica powder more likely to be aggregated. Thus, the length of the longer side of the crushing blade is preferably not more than 300 mm.

The thickness of the crushing blade is not particularly limited, but is preferably 1 mm to 5 mm.

Next, the rotation speed of the crushing blade is also directly related to the crushing energy, as expressed by the above formula. Depending on the size of the crushing blade, the rotation speed of the crushing blade is preferably 50 (rad/s) to 300 (rad/s). An excessively low rotation speed decreases the crushing effect, and a rotation speed exceeding 310 (rad/s) causes the tendency of the crushing energy to exceed 10 J. Setting the rotation speed of the crushing blade to a small value tends to reduce mechanical load.

Thus, each of the length of the longer side, the length of the short side, and the thickness of the crushing blade, the number of crushing blades, and the rotation speed of the crushing blade is selected relatively within the range described above in consideration of the material of the crushing blade, namely the weight of the crushing blade, so that the crushing energy per rotating shaft as calculated by the expressions (C) to (F) is 0.3 J to 10 J.

A position at which the rotating shaft of the crushing blade is mounted is not particularly limited, provided that the crushing blade is located in a powder contact portion in the apparatus. For example, in a case where a V-blender, a rocking mixer, or a double-cone mixing apparatus is used, the crushing blade can contact power wherever the rotating shaft is mounted in the space inside the mixing apparatus. Thus, the rotating shaft can be mounted at any position on the inner side surface of a body of the mixing apparatus or on inner wall surfaces of both ends of the mixing apparatus. In a case where an air blender is used, the rotating shaft need only be mounted so that the crushing blade efficiently contacts powder, in view of the flow of the silica powder which is produced by air flow. In this case, the rotating shaft can be mounted at any position on the inner side surface of a body of the air blender and on the inner wall surface of a ceiling part of the air blender.

The size of the above-described mixing apparatus to be used for the mixing is not particularly limited, but a mixing apparatus with an inner capacity of 10 L to 4 m³ is suitably used.

<Surface Treatment Method>

The following will describe a method of performing dry surface treatment with use of the surface treatment apparatus.

In the present embodiment, the silica powder as a base material is fed to the surface treatment apparatus. The amount of base silica powder to be fed to the surface treatment apparatus is not particularly limited, provided that the surface treatment apparatus can mix the base material fed thereto. In view of typical treatment efficiency, the amount of base silica powder to be fed to the mixing apparatus is preferably 10% to 60% of the inner capacity of the mixing apparatus, and more preferably 30% to 50% of the inner capacity of the mixing apparatus.

Next, the surface treatment agent is fed to the mixing apparatus to which the base silica powder has been fed. The amount of surface treatment agent to be fed to the mixing apparatus is as described above.

The surface treatment agent may be mixed with the silica powder after the surface treatment agent has been diluted with a solvent. The solvent to be used is not particularly limited, provided that the surface treatment agent is dissolved therein. The solvent is not particularly limited, provided that it does not affect the functional group of the surface treatment agent, and a known solvent can be used. For example, alcohols such as methyl alcohol, ethyl alcohol, 1-propylalcohol, and 2-propylalcohol are suitably used. Alternatively, organic solvents other than alcohols can be used. A dilution factor by which the surface treatment agent is diluted with the solvent is not particularly limited, but the surface treatment agent is typically diluted by a factor of about 2 to 5 before use.

Additives such as a polymerization inhibitor, a polymerization retarder, and an ultraviolet absorber may be used as necessary. These additives are not particularly limited, and known additives can be used.

A method for adding the surface treatment agent is not particularly limited. The surface treatment agent may be added in its entirety at a time or may be added continuously or intermittently while being mixed. However, in a case where a large amount of base silica powder is to be surface-treated, or in a case where a large amount of surface treatment agent is provided, it is preferable that the surface treatment agent be added continuously or intermittently while being mixed. The addition of the surface treatment agent is preferably carried out by dropping or spraying with use of a pump or the like. A known spray nozzle or the like can be suitably used for the spraying.

In a case where the surface treatment agent is in gaseous form, the surface treatment agent can be introduced by blowing the surface treatment agent into the reaction apparatus.

In a case where the surface treatment agent is added continuously or intermittently, a feed rate of the surface treatment agent is not particularly limited, but is determined in view of, for example, the amount of surface treatment agent to be used. Suitably, the feed rate can be determined in the following manner. That is, an experiment is conducted in which a colorant is fed while the base silica powder is preliminarily stirred in the mixing apparatus, the feed rate to the extent that the base silica powder is uniformly colored is obtained, and about half of the obtained colorant feed rate is considered to be the feed rate. Here, the reason why the feed rate is set to about half of the colorant feed rate is that uniform mixing is carried out with reliability.

A time required for the uniform coloring described above varies depending on, for example, a stirring/fluidization method and the capacity of the mixing apparatus. However, generally, it is preferable that each condition be set so that the surface treatment agent is fed at a rate of 0.01 ml/min to 10 ml/min per 100 g of the base silica powder. It is particularly preferable that the surface treatment agent is fed at a rate of 0.03 ml/min to 5 ml/min per 100 g of the base silica powder. Especially, in a case where a large amount of surface treatment agent is to be used, feeding the surface treatment agent at a low rate increases a treatment time and thus leads to poor productivity. In a case where the surface treatment agent is fed at a time or at an excessively high rate, droplets of the surface treatment agent become larger, and aggregated particles tend to be formed in the silica powder.

Further, the atmosphere in the mixing apparatus is not particularly limited. However, inert gas such as nitrogen, helium, and argon is preferably used. This makes it possible to suppress hydrolysis caused by water and oxidative decomposition caused by oxygen.

The temperature at the time when the surface treatment agent is fed and mixed so as to be brought into contact with the base silica powder is not particularly limited. However, such a temperature is generally about −10° C. to 40° C. This is because an excessively high temperature may cause polymerization of the surface treatment agent or rapid vaporization of the surface treatment agent, depending on the type of the surface treatment agent.

The mixing need only be performed so that the surface treatment agent is uniformly mixed with the silica powder. A required time for feeding the surface treatment agent in its entirety (i.e., a required time for mixing) is determined from the feed rate and the amount of surface treatment agent to be fed.

At the time of mixing of the base silica powder and the surface treatment agent, aggregated particles are usually formed due to uneven distribution of the surface treatment agent and/or strong mixing energy. However, in a case where a mixing means that does not use a rotating body having a drive unit is used, formation of such aggregated particles in the silica powder is suppressed. Furthermore, by the crushing blade mounted inside the mixing apparatus, the aggregated particles formed are efficiently crushed before turning into strongly aggregated particles. This allows the silica powder to have extremely few aggregated particles even after the surface treatment agent has been added to and mixed with the silica powder. Further, in a case where such a mixing apparatus is used, surface-treated silica powder such that the surfaces of the particles are uniformly treated with the surface treatment agent and that a reduced amount of aggregated particles are formed therein is obtained even if an excessive amount of surface treatment agent is fed to the mixing apparatus.

Through the above-described addition and mixing of the surface treatment agent, the silica powder is surface-treated. It is preferable that, after the addition and mixing, an aging treatment be additionally carried out so that a reaction of a reactive group of the surface treatment agent adhered on the silica powder surface with the silica surface sufficiently proceeds. The aging treatment is carried out by the application of heat or without the application of heat. In a case where an apparatus having a heating means is used as the mixing apparatus, the aging treatment can be carried out by using such an apparatus as it is to perform heating through the application of heat while performing stirring and fluidization. Alternatively, the silica powder sufficiently mixed with the surface treatment agent may be taken out and heated in a separate apparatus, so that the silica powder can be heated while being subjected to stirring or the like operation or without being subjected to stirring or the like operation.

In the latter case, an atmosphere gas in a separate aging apparatus is not particularly limited. However, an inert gas atmosphere such as nitrogen, helium, and argon is preferable, as in the case of the atmosphere gas in the above-described mixing apparatus.

With regard to a temperature at which the aging treatment is carried out, an excessively low temperature causes the reaction to proceed slowly and thus leads to decreased efficiency of production, and an excessively high temperature encourages decomposition of the surface treatment agent and aggregation caused by a rapid polymerization reaction. Thus, the temperature at which the aging treatment is carried out is generally 25° C. to 300° C., and preferably 40° C. to 250° C., depending on the surface treatment agent to be used. When the temperature condition is in this range, a vapor pressure of the surface treatment agent in the mixing apparatus is preferably not less than 1 kPa. It is more preferable that heating be performed at a temperature such that the vapor pressure of the surface treatment agent is not less than 10 kPa. In the surface treatment of the silica powder, the pressure inside the mixing apparatus may be any of a normal pressure, an increased pressure, and a negative pressure.

An aging treatment time is determined as appropriate according to the reactivity of the surface treatment agent to be used. Usually, a sufficient reaction rate can be achieved within 1 hour to 500 hours. After the completion of the aging treatment, contents are taken out of a vessel used for aging and are then charged into a container for storage or a bag for storage to carry out, for example, storage and shipment.

### 2. Surface-Treated Silica Powder Production Method by Wet Surface Treatment (Second Embodiment)

In the wet surface treatment, surface treatment is generally carried out by the following procedure. That is, a dispersion liquid is prepared by mixing base silica powder and a solvent. A predetermined amount of surface treatment agent is added to the dispersion liquid while the dispersion liquid is stirred in a reaction vessel, and the dispersion and the surface treatment agent are allowed to react for a predetermined period of time. After that, solid-liquid separation is carried out to collect a solid content (surface-treated silica), and the solid content is then dried. In this way, it is possible to obtain surface-treated silica powder. At the solid-liquid separation, it is preferable that a coagulant be added to increase separation capability. The following will describe the procedure (steps) in more detail.

<Surface Treatment Agent and Surface Treatment Amount>

As the surface treatment agent, the surface treatment agents provided in the above-described surface-treated silica powder production method by dry surface treatment can preferably be used. That is, the surface treatment agent is preferably at least one selected from silicone oil, silane coupling agents, siloxanes, and silazanes.

Only one type of the surface treatment agents may be used alone, or two or more types thereof may be used in combination.

<Solvent>

In the present embodiment, the solvent used for the wet surface treatment is not particularly limited, and water and known organic solvents can be used. At least one selected from water and known organic solvents is selected as appropriate according to the type of surface treatment agent to be used.

Examples of the organic solvent include: alcohols such as methyl alcohol, ethyl alcohol, 1-propyl alcohol, 2-propyl alcohol, and butyl alcohol; ethers such as tetrahydrofuran and dioxane; amide compounds such as dimethylformamide, dimethylacetamide, and N-methylpyrrolidone; sulfoxides such as dimethyl sulfoxide and sulfolane; hydrocarbons such as hexane, toluene and benzene; chlorinated hydrocarbons such as methylene chloride and chloroform; ketones such as acetone and methyl ethyl ketone; esters such as ethyl acetate; and nitriles such as acetonitrile.

Only one type of the water and the organic solvents may be used alone, or two or more types thereof may be used as a solvent mixture. Depending on the type of surface treatment agent to be used, the selection may be made in consideration of, for example, solubility of the surface treatment agent, reactivity thereof, and stability of functional groups thereof.

In order to use a mixture of water and an organic solvent, it is preferable that the water and the organic solvent be uniformly mixed. Generally, among the organic solvents listed above, examples of an organic solvent that is uniformly mixed with water include: alcohols such as methyl alcohol, ethyl alcohol, 1-propyl alcohol, 2-propyl alcohol, and butyl alcohol; ethers such as tetrahydrofuran and dioxane; and amide compounds such as dimethylformamide, dimethylacetamide, and N-methylpyrrolidone.

<Wet Surface Treatment Apparatus>

As the surface treatment apparatus used in the present embodiment, a known stirrer or a known mixer is used without any particular limitation.

As the stirring blade of the stirrer, known stirring blades are used without any particular limitation. Examples of typical stirring blades include an inclined paddle blade, a turbine blade, a three swept blade, an anchor blade, a Fullzone blade, a Twin stir blade, and a Maxblend blade.

As the reactor having such a stirrer, a reactor with a common shape, namely a hemispherical reactor or a flat bottom or round bottom cylindrical reactor, and a reactor having a baffle plate placed therein can be used without any particular limitation. The material of the reactor is not particularly limited, and a reactor made of glass, a metal such as stainless steel (including a glass-coated or resin-coated metal), or a resin can be used. In order to obtain surface-treated silica powder with high purity, it is preferable that the reactor be made of a material having excellent abrasion resistance.

<Surface Treatment Method>

A typical method for performing wet surface treatment with use of the above-described surface treatment apparatus will be described.

First, the base silica powder and the solvent as described above are fed to the surface treatment apparatus to prepare a silica dispersion liquid. At this time, the amount of the solvent to be fed is preferably 50 parts by mass to 2000 parts by mass, and more preferably 80 parts by mass to 1000 parts by mass, relative to 100 parts by mass of the base silica powder.

The surface treatment agent is added to the silica dispersion liquid as described above. A method of adding the surface treatment agent is not particularly limited. In a case where the surface treatment agent is a low viscosity liquid at normal temperature and normal pressure, the surface treatment agent need only be introduced to the dispersion liquid. The surface treatment agent may be introduced in its entirety at a time or may be introduced in a plurality of portions several times. The method of introducing the surface treatment agent is not particularly limited, and the surface treatment agent may be dropped or sprayed in spray form. In a case where the surface treatment agent is a high viscosity liquid or solid, the surface treatment agent is added to an appropriate organic solvent to produce a solution or a dispersion liquid, and the solution or the dispersion liquid is added to the dispersion in a manner similar to that of the low viscosity liquid.

Here, as the organic solvent used for dilution, a known solvent that does not affect the functional groups of the surface treatment agent to be used can be used. For example, alcohols such as methyl alcohol, ethyl alcohol, 1-propyl alcohol, and 2-propyl alcohol are suitably used, but organic solvents other than alcohols can also be used. A dilution factor for the solvent is not particularly limited, but the surface treatment agent is typically diluted by a factor of about 2 to 5.

In a case where the surface treatment agent is in gaseous form, the surface treatment agent can be blown into the dispersion liquid so as to form fine bubbles in the dispersion liquid.

A treatment temperature at which the surface treatment is carried out is determined in consideration of, for example, physical properties such as a solidification point and a boiling point of the solvent to be used and the reactivity of the surface treatment agent to be used. An excessively low treatment temperature causes the reaction to proceed slowly, and an excessively high treatment temperature leads to a complicated operation. Thus, the treatment temperature is preferably 10° C. to 150° C., and more preferably 20° C. to 100° C.

A treatment time for which the surface treatment is carried out is not particularly limited and is determined in consideration of, for example, the reactivity of the surface treatment agent to be used and the treatment temperature thereof. In view of achieving both the surface treatment reaction proceeding sufficiently and the shortening of the length of the process time, the treatment time is preferably 0.1 hours to 48 hours, and more preferably 0.5 hours to 24 hours. Note here that the treatment time is a time from the start of addition of the surface treatment agent to the addition of a coagulant described later, or, when the coagulant is not used, to the solid-liquid separation.

At the time of carrying out the surface treatment, a known catalyst can be used depending on the type of the surface treatment agent. Examples of such a catalyst include: acidic catalysts including inorganic acids, such as hydrochloric acid, nitric acid, and sulfuric acid, acetic acid, oxalic acid, and citric acid; and alkaline catalysts including amine compounds, such as ammonia, trimethylamine, and triethylamine, and alkali metal hydroxide.

The amount of the catalyst to be used is determined as appropriate in consideration of the reactivity of the surface treatment agent. For example, the amount of the catalyst present in a reaction liquid is preferably 0.01 parts by mass to 50 parts by mass, relative to 100 parts by mass of the surface treatment agent to be used, and it is more preferable that the catalyst be used in an amount in a range of 0.01 parts by mass to 35 parts by mass.

In the present embodiment, it is also preferable that, after the addition of the surface treatment agent, the dispersion liquid be filtered before drying, which will be described later, or, when the coagulant is to be added, prior to the addition of the coagulant. That is, since coarse particles, agglomerates, and the like caused by the adhesion of particles may be contained, the coarse particles, agglomerates, and the like may be reduced by removing them with use of a filter. As the filter, a filter having an opening that allows surface-treated primary particles to pass through and does not allow coarse particles, agglomerates, and the like significantly larger than the primary particles to pass through is used.

After the surface treatment is completed, the surface-treated silica powder is taken out by solid-liquid separation, but a known coagulant may be added to the dispersion liquid prior to the solid-liquid separation. Adding the coagulant to the dispersion liquid forms loose aggregates of the surface-treated silica powder in the dispersion liquid. These aggregates can be stably present in the dispersion liquid due to the coagulant or its derivative in the dispersion liquid and therefore can be easily collected by filtration or the like.

As such a coagulant, ammonium salts such as ammonium carbonate, ammonium hydrogen carbonate, and ammonium carbamate can be suitably used. These coagulants are easily decomposed and removed by slight heating and thus have an advantage in facilitating production of high-purity surface-treated silica powder.

The proportion of the coagulant to be used and the method of adding the coagulant can be set as described below according to the type of coagulant to be used. The proportion of the coagulant to be used is set in consideration of the balance between the degree to which loose aggregates of the surface-treated silica powder are formed in the dispersion liquid and the waste resulting from using an unreasonably large amount of raw material.

The proportion of the coagulant to be used is preferably not less than 0.001 parts by mass, more preferably 0.001 parts by mass to 50 parts by mass, even more preferably 0.1 parts by mass to 20 parts by mass, and particularly preferably 0.5 parts by mass to 10 parts by mass, relative to 100 parts by mass of the base silica powder contained as a raw material in the dispersion liquid.

The above-described coagulant such as ammonium carbonate, ammonium hydrogen carbonate, or ammonium carbamate is usually a solid, but, in the present embodiment, may be added in a solid state or in a solution state of being dissolved in an appropriate solvent. The solvent used when added in a solution state is not particularly limited, provided that it dissolves the coagulant to be used. However, water is preferably used from the viewpoint of having a high dissolving ability and being easily removed after solid-liquid separation. The concentration of the coagulant when used in a solution state is not particularly limited, provided that it is within such a range that the coagulant dissolves. An excessively low concentration of the coagulant requires a larger amount of solution to be used, which is economically disadvantageous. The concentration is therefore preferably 0.5% by mass to 15% by mass, and particularly preferably 1% by mass to 12% by mass. Further, since the effect of the coagulant can be easily obtained, it is preferable that the dispersion liquid obtained after the addition of the coagulant contain water in the proportion of not less than 5% by mass.

Only one type of the coagulants may be used alone, or two or more types thereof may be used in combination.

Especially, a mixture of ammonium hydrogen carbonate and ammonium carbamate, which is commercially available as what is called “ammonium carbonate”, can be used as it is or in the form of a solution of ammonium carbonate and an appropriate solvent. In this case, the total proportion of ammonium hydrogen carbonate and ammonium carbamate, and the type of solvent and the concentration of the solution in the case where the mixture of ammonium hydrogen carbonate and ammonium carbamate is used in the form of a solution, are similar to those described above for ammonium carbonate, ammonium hydrogen carbonate, or ammonium carbamate.

With regard to the temperature of the dispersion liquid of the surface-treated silica powder at the time of adding the coagulant, it is desired to select and set such a temperature that allows loose aggregates of the surface-treated silica powder formed by addition of the coagulant to stably present in the dispersion liquid. From this viewpoint, the temperature of the dispersion liquid is preferably −10° C. to 60° C., and more preferably 10° C. to 50° C.

It is preferable to age the dispersion liquid after the addition of the coagulant. Namely, it is preferable to let the dispersion liquid stand for a certain time until solid-liquid separation in the subsequent step. Aging the dispersion liquid after addition of the coagulant is preferable as it facilitates the formation of loose aggregates of the surface-treated silica powder. The longer the aging time, the better. However, aging the dispersion liquid for an excessively long time is economically disadvantageous. An excessively short aging time fails to provide sufficient formation of loose aggregates of the surface-treated silica powder. The aging time is therefore preferably 0.5 hours to 72 hours, and particularly preferably 1 hour to 48 hours. The temperature of the dispersion liquid at the time of aging is not particularly limited. The temperature of the dispersion liquid at the time of aging can be in the same temperature range as the preferable temperature range of the dispersion liquid at the time of adding the coagulant. The temperature of the dispersion liquid at the time of aging need only be the same as that of the dispersion at the time of adding the coagulant.

As a solid-liquid separation method for extracting the surface-treated silica from the dispersion liquid after the surface treatment or the dispersion liquid to which the coagulant has been added after the surface treatment, known methods such as a solvent distillation method, a centrifugal separation method, and a filtration method can be used without any particular limitation. A filtration method is preferably selected because it is more likely to produce surface-treated silica powder that is easily loosened after drying and because it is easily operated. The filtration method is not particularly limited, and a known device that performs, for example, filtration under reduced pressure, centrifugal filtration, or pressure filtration may be selected.

Filter paper, filter, filter cloth, etc. (hereinafter referred to collectively as “filter paper, etc.”) used in the filtration method can be used without any particular limitation, provided that they are industrially available. The filter paper, etc. are selected as appropriate according to, for example, the scale of a separation apparatus (filter), the average particle diameter of silica to be collected.

Surface-treated silica is collected as a cake by solid-liquid separation by the filtration method or the like. By rinsing the obtained cake with an appropriate solvent such as water or alcohol, the solvent used in the surface treatment step and the unreacted surface treatment agent can be decomposed or removed.

Next, the cake of the surface-treated silica collected by the solid-liquid separation is dried.

A drying temperature is not particularly limited. However, an excessively high drying temperature is not preferable because the functional groups introduced into the silica surface are decomposed. Further, in a case where the cake contains a coagulant, setting the drying temperature to 35° C. or higher enables the coagulant to be easily removed by thermal decomposition and enables further improvement in crushability of the surface-treated silica powder. Thus, the drying temperature is preferably 35° C. to 200° C., more preferably 80° C. to 180° C., and even more preferably 100° C. to 150° C.

A drying method is not particularly limited, and known drying methods such as air-blast drying or drying under reduced pressure can be employed. Drying under reduced pressure is preferably employed because surface-treated silica powder obtained by drying under reduced pressure tends to have higher crushability.

A drying time is not particularly limited and is selected as appropriate according to the conditions for drying including, for example, the drying temperature and pressure. In general, in a case where the drying time is about 2 hours to 48 hours, sufficiently dried surface-treated silica powder can be obtained.

Further, since the surface-treated silica powder obtained after drying may be lightly aggregated, the surface-treated silica powder may be crushed with use of a jet mill, a ball mill, or the like as necessary to make a final product. The crushing can also be carried out in the above-mentioned dry surface treatment.

The surface-treated silica powder obtained by the above-mentioned production method in accordance with an embodiment of the present invention is preferably such that the cumulative 50% mass diameter D₅₀ (hereinafter also referred to as “median diameter D₅₀”) of the mass-based particle size distribution obtained by a laser diffraction scattering method is not less than 300 nm and not more than 500 nm. A larger cumulative 50% mass diameter D₅₀ of the mass-based particle size distribution than the above-described range results in a resin composition, in spite of having low viscosity, having an excessively large silica particle diameter in relation to the gap. This leads to voids generated during gap permeation and causes a molding defect. That is, sufficient narrow gap permeability cannot be obtained. On the other hand, a smaller cumulative 50% mass diameter D₅₀ of the mass-based particle size distribution than the above-described range is not preferable because it results in a resin composition having high viscosity.

The mass-based particle size distribution obtained by a laser diffraction scattering method is a mass-based particle size distribution of dispersed particles obtained by weighing out 0.1 g of the surface-treated silica powder with use of an electronic scale, adding approximately 40 mL of ethanol, and dispersing the surface-treated silica powder at an output of 40 W and for a treatment time of 2 minutes with use of an ultrasonic homogenizer.

Note that, as described above, the particle size property of the base silica powder is measured by the centrifugal sedimentation method, whereas the particle size property of the silica powder after the surface treatment is measured by the laser diffraction scattering method. This is because the particle size property of the base silica powder not having been surface-treated, which is highly hydrophilic, can be measured more accurately by the centrifugal sedimentation method using water as the dispersion medium, while the particle size property of the surface-treated silica powder, whose extent of hydrophobization is increased by surface treatment, is generally measured suitably by the laser diffraction scattering method in which an organic solvent such as alcohol including ethanol is used as a dispersion medium.

The property such that the particle size distribution is appropriately adjusted is specified by a relation between the cumulative 50% mass diameter D50 and the cumulative 90% mass diameter D₉₀ being such that {(D₉₀−D₅₀)/D₅₀}×100 is not less than 25% and not more than 40%. Note that this range differs from that of the base silica powder. This is because there is a difference between the centrifugal sedimentation method and the laser diffraction scattering method, and the particle size distribution is relatively narrowly measured in the laser diffraction scattering method. The particle size distribution expressed by the above-described formula exceeding 40% indicates the presence of many coarse particles and thus causes voids in a resulting resin composition or the like. On the other hand, the particle size distribution of less than 25%, which is a narrow particle size distribution, is not preferable because it does not achieve low viscosity. More preferably, {(D₉₀−D₅₀)/D₅₀}×100 is not less than 25% and not more than 35%.

Further, the surface-treated silica powder obtained in an embodiment of the present invention preferably has a geometric standard deviation σ_{g} of the volume-based particle size distribution obtained by laser diffractometry in a range of not less than 1.20 and not more than 1.40. It can be said that a small geometric standard deviation σ_{g} shows a narrow particle size distribution, and thus it can be said that the amount of coarse particles is decreased. However, the presence of a particle size distribution in a certain range is likely to decrease the viscosity obtained when the surface-treated silica powder is added to a resin.

The geometric standard deviation σ_{g} is a geometric standard deviation calculated by fitting a lognormal distribution (least squares method) to the mass-based particle size distribution obtained by a laser diffraction scattering method in a range of a cumulative frequency of not less than 10 wt % and not more than 90 wt %.

By performing treatment by the method as mentioned above so as not to cause aggregation resulting from surface treatment, it is possible to obtain surface-treated silica powder having the particle diameter properties as described above with use of the base silica powder.

The surface-treated silica powder obtained by the production method in accordance with an embodiment of the present invention is preferably such that element contents of iron, nickel, chromium, and aluminum are each less than 1 ppm. This enables reduction of short circuits between metal lines in a semiconductor device.

Further, the surface-treated silica powder obtained by the production method in accordance with an embodiment of the present invention is preferably such that ion contents of sodium ions, potassium ions, and chloride ions which are measured by a hot water extraction method are each less than 1 ppm. This enables reduction of malfunction of the semiconductor device and reduction of corrosion of the metal lines in the semiconductor device.

By performing an operation, with a general caution exercised against contamination of metal impurities, with the use of the above-described base silica powder and without the use of a surface treatment agent containing the above-described metals as the surface treatment agent, it is possible to obtain the above-described surface-treated silica powder having a low content of various metal impurities.

Further, it is preferable that the particles constituting the surface-treated silica powder obtained by the production method in accordance with an embodiment of the present invention are shaped in a sphere. Such a shape can be grasped by, for example, electron microscope observation.

In general, surface treatment does not cause any change in the shape that can be grasped by electron microscope observation. Thus, if spherical silica powder is employed as the base silica powder, surface-treated silica also becomes spherical.

Since the surface-treated silica powder obtained by the production method in accordance with an embodiment of the present invention has the median diameter D50 and the like as described above, the specific surface area usually measured by the BET one-point method is about not less than 6 m²/g and not more than 14 m²/g.

The use to which the surface-treated silica powder obtained by the production method in accordance with an embodiment of the present invention as described above is put is not particularly limited. The surface-treated silica powder obtained by the production method in accordance with an embodiment of the present invention is used as, for example, a filler for a semiconductor sealant or for a semiconductor mounting adhesive, a filler for a die attach film or for a die attach paste, or a filler for a resin composition such as an insulating film for a semiconductor package substrate. Particularly, the surface-treated silica powder obtained in an embodiment of the present invention can be suitably used as a filler for a resin composition for high-density mounting.

The type of resin with which the surface-treated silica powder is blended is not particularly limited. The type of the resin may be selected as appropriate depending on a desired use, and examples thereof include epoxy resin, acrylic resin, silicone resin, olefin-based resin, polyimide resin, and polyester-based resin.

As a method for producing the resin composition, a known method may be employed as appropriate, and surface-treated silica powder may be mixed with various resins and other components to be blended as necessary.

The surface-treated silica powder obtained by the production method in accordance with an embodiment of the present invention can be dispersed in a dispersion medium to form a dispersion. The dispersion may be a dispersion liquid in liquid form, or may be a solid dispersion obtained by, for example, solidifying such a dispersion liquid. The solvent used for dispersing the surface-treated silica powder is not particularly limited as long as the solvent is a solvent in which the surface-treated silica powder can be easily dispersed.

As such a solvent, for example, water and organic solvents such as alcohols, ethers, and ketones can be used. Examples of the alcohols include methanol, ethanol, and 2-propyl alcohol. As the solvent, a mixed solvent of water and any one or more of the above organic solvents may be used. To improve the stability and dispersibility of the surface-treated silica powder, various additives may be added, including a dispersant such as a surfactant, a thickener, a wetting agent, a defoaming agent, and an acidic or alkaline pH adjusting agent. Further, the pH of the dispersion is not limited.

When such a dispersion is mixed with the resin, a resin composition containing the silica powder in a better dispersion state in the resin can be obtained than when dried silica powder is mixed with the resin. A better dispersion state of particles means fewer aggregated particles in the resin composition. This enables the resin composition containing the silica powder in accordance with an embodiment of the present invention as a filler to have further improved performance in terms of both the viscometric property and the gap permeability.

Further, the surface-treated silica powder obtained in accordance with an embodiment of the present invention can also be used as, for example, abrasive grains of chemical mechanical polishing (CMP) abrasives, abrasive grains for grind stones used for grinding, etc., a toner external additive, an additive for liquid crystal sealants, a dental filler, and an inkjet coating agent.

### EXAMPLES

The following will specifically describe the present invention based on Examples in embodiments of the present invention. Note, however, that the present invention is not limited by these Examples.

Measurements and evaluations of physical properties of base silica powder and surface-treated silica powder are performed by the following methods.

(1) BET Specific Surface Area

The BET specific surface area S (m²/g) was measured by the nitrogen adsorption BET one-point method using a specific surface area measuring device SA-1000 manufactured by Shibata Rikagaku Co., Ltd.

(2) Absorbance τ₇₀₀

0.3 g of base silica powder and 20 ml of distilled water were put into a glass sample tube bottle (manufactured by AS ONE Corporation, content of 30 ml, outer diameter of about 28 mm). The sample tube bottle containing a sample was placed in a manner that a probe tip of an ultrasonic cell crusher (manufactured by BRANSON Ltd., Sonifier II, Model 250D, probe: 1.4 inches) was 15 mm below the water surface level, and the silica powder was dispersed in the distilled water under the conditions of an output of 20 W and a dispersion time of 15 minutes, so that an aqueous suspension having a silica concentration of 1.5 wt % was prepared. Subsequently, this aqueous suspension was further diluted with distilled water to reduce the concentration to one-twentieth, so that an aqueous suspension containing silica at a concentration of 0.075 wt % was obtained.

The absorbance 1700 of the obtained aqueous suspension having a silica concentration of 0.075 wt % with respect to light having a wavelength of 700 nm was measured using a spectrophotometer V-630 manufactured by JASCO Corporation. At the time of measurement, the absorbance σ₄₆₀ of the aqueous suspension having a silica concentration of 0.075 wt % with respect to light having a wavelength of 460 nm was also measured, and a dispersibility index n defined by ln (σ₇₀₀/σ₄₆₀)/ln (460/700) was also obtained.

(3) Mass-Based Particle Size Distribution by Centrifugal Sedimentation Method

A mass-based particle size distribution of the aqueous suspension having a silica concentration of 1.5 wt % obtained by the above-described method was measured using a disk centrifugal particle size distribution measuring device DC24000 manufactured by CPS Instruments Inc. The measurement conditions were a rotation speed of 9000 rpm and a silica true density of 2.2 g/cm³.

A cumulative 50% mass diameter D₅₀ and a cumulative 90 mass % diameter D₉₀ were calculated from the obtained mass-based particle size distribution. Further, a geometric standard deviation σ_{g} was calculated by fitting a lognormal distribution to the obtained mass-based particle size distribution in a range of a cumulative frequency of not less than 10% by mass and not more than 90% by mass.

(4) Mass-Based Particle Size Distribution by Laser Diffraction Scattering Method

Approximately 0.1 g of surface-treated silica powder was weighed out in a 50-mL glass bottle with use of an electronic balance. Approximately 40 ml of ethanol was added, and the surface-treated silica powder was dispersed with use of an ultrasonic homogenizer (Sonifier 250, manufactured by BRANSON) under conditions of 40 W and 10 minutes. Subsequently, an average particle diameter (nm) and a coefficient of variation of the surface-treated silica powder were measured with use of a laser diffraction scattering method-based particle size distribution measurement device (LS 13 320, manufactured by Beckman Coulter, Inc.). The average particle diameter (nm) herein means a volume-based cumulative 50% diameter.

A cumulative 50% mass diameter D₅₀ and a cumulative 90 mass % diameter D₉₀ were calculated from the obtained mass-based particle size distribution. Further, a geometric standard deviation σ_{g} was calculated by fitting a lognormal distribution to the obtained mass-based particle size distribution in a range of a cumulative frequency of not less than 10% by mass and not more than 90% by mass. Further, with regard to 5 μm or larger coarse particles in a laser diffraction scattering method, whether or not there was any signal indicating not less than 5 μm was checked.

(5) Bulk Density

The loose bulk density and the packed bulk density were measured using a powder characteristics evaluation device powder tester PT-X type manufactured by Hosokawa Micron Corporation. The “loose bulk density” in the present invention refers to a bulk density in a loosely filled state, which is measured in the following manner. That is, a sample is uniformly supplied, to a cylindrical container (material: stainless steel) having a volume of 100 mL, from 18 cm above the cylindrical container, the upper surface is scraped, and weighing is carried out.

On the other hand, a “packed bulk density” refers to a bulk density in a densely filled state which is brought about by tapping the loosely filled container. Here, the tapping refers to an operation in which a container filled with a sample is repeatedly dropped from a constant height to give a light impact on the bottom so that the container is densely filled with the sample. Specifically, after scraping the upper surface and performing weighing to measure the loose bulk density, a cap (equipment of the powder tester manufactured by Hosokawa Micron Corporation below) is further put on this container, and powder is added up to the upper edge of the cap. Then, tapping is performed 180 times. After the tapping is finished, the cap is removed, the powder is scraped on the upper surface of the container, and weighing is performed. The bulk density in this state is regarded as the packed bulk density.

(6) Element Contents of Iron, Nickel, Chromium, and Aluminum

2 g of dried silica powder or surface-treated silica powder was precisely weighed and was transferred to a platinum dish, and 10 mL of concentrated nitric acid and 10 mL of hydrofluoric acid were added in this order. The platinum dish was placed on a hot plate set at 200° C. and was heated to dry the contents. After cooling to room temperature, 2 mL of concentrated nitric acid was further added, and the platinum dish was placed on a hot plate set at 200° C. and was heated for dissolution. After cooling to room temperature, the solution, which is the contents in the platinum dish, was transferred to a volumetric flask having a capacity of 50 mL, and was diluted with ultrapure water so as to be aligned with a marked line. In the resultant solution as a sample, element contents of iron, nickel, chromium, and aluminum were measured by an ICP emission spectrometer (manufactured by Shimadzu Corporation, model number ICPS-1000IV).

(7) Ion Content by Hot Water Extraction Method

5 g of silica powder or surface-treated silica powder was added to 50 g of ultrapure water, and a resultant solution was heated at 120° C. for 24 hours using a decomposition container made of fluororesin to carry out hot water extraction of ions. The ultrapure water and silica powder or surface-treated silica powder were weighed to 0.1 mg units. Subsequently, the solid content was separated using a centrifuge to obtain a measurement sample. The same operation was performed only with ultrapure water, and this ultrapure water was used as a blank sample for measurement.

The concentrations of sodium ions, potassium ions, and chloride ions contained in the measurement sample and in the blank sample were quantified using the ion chromatography system ICS-2100 manufactured by Nippon Dionex Co., Ltd., and were calculated using the following formula:

C_{Silica}=(C_{Sample}−C_{Blank})×M_{PW}/M_{Silica}

wherein:

C_{Silica} is an ion concentration in silica (ppm),

C_{Sample} is an ion concentration in the measurement sample (ppm),

C_{Blank} is an ion concentration in the blank sample (ppm),

M_{PW} is the amount of ultrapure water (g), and

M_{Silica} is a silica weight (g).

The C_{Blank} of each kind of ions was all 0 ppm.

(8) Electron Microscope Observation

0.03 g of silica powder was weighed, was added to 30 ml of ethanol, and was then dispersed for 5 minutes using an ultrasonic cleaner to obtain an ethanol suspension. After this suspension was dropped onto a silicon wafer, the silicon wafer was dried, and the particle diameter shape was determined by SEM observation of silica using a field emission scanning electron microscope S-5500 manufactured by Hitachi High-Technologies Corporation.

(9) Measurement of Surface Carbon Amount

The amount (mass %) of carbons of surface-treated silica powder was measured by a combustion oxidation method (EMIA-511, manufactured by Horiba Ltd.). Specifically, the amount of carbons of the surface-treated silica powder was determined by heating a surface-treated silica powder sample to 1350° C. in an oxygen atmosphere and converting the amount of carbons obtained into an amount per unit mass. Note that the surface-treated silica powder used for the measurement was subjected, as a pretreatment, to removal of water and the like adsorbed in the air therefrom through heating at 80° C. and pressure reduction in a system, and was then used for the measurement of the carbon content.

(10) Evaluation of Dispersibility of Silica Powder Using Epoxy Resin

36 g of base silica powder or surface-treated silica powder was added to 24 g of bisphenol A and F-type epoxy resin (ZX-1059, manufactured by NIPPON STEEL CHEMICAL & MATERIAL CO., LTD.), and a mixture was kneaded by hand. A hand-kneaded resin composition was pre-kneaded with use of a rotating and revolving mixer (Awatori Rentaro AR-500, manufactured by THINKY CORPORATION) (kneading: 1000 rpm, 8 minutes; defoaming: 2000 rpm, 2 minutes). A pre-kneaded resin composition was stored in a constant temperature water bath at 25° C. and then kneaded with use of a three roll mill (BR-150HCV, manufactured by AIMEX CO., LTD., roll diameter of φ63.5). The kneading was performed under the conditions that a kneading temperature was 25° C., a roll-to-roll distance was 20 μm, and the number of times of kneading was eight times. The resin composition thus obtained was defoamed for 30 minutes under reduced pressure with use of a vacuum pump (TSW-150 manufactured by SATO VAC INC.).

The kneaded resin composition was measured for initial viscosity (η₁) and viscosity after 1 week (η₂) at a shear rate of 1 s⁻¹ with use of a rheometer (HAAKE MARS40, manufactured by Thermo Fisher Scientific Inc.). Note that measurement temperatures were 25° C. and 110° C., and the sensor used was C35/1 (cone plate type; diameter of 35 mm; angle: 1 degree; material: titanium).

Using the viscosity at the preparation of the resin composition (η₁) and the viscosity after 1 week (η₂), the rate of change in viscosity with time was calculated by the following formula. Note that the resin composition was stored by allowing it to stand still at 25° C.

Rate of change in viscosity with time [%]=((η₂−η₁)/η₁)×100

(11) Evaluation of Dispersibility of Silica Powder Using Thermosetting Resin

36 g of base silica powder or surface-treated silica powder was added to a mixture of 17 g of bisphenol F-type epoxy resin (YDF-8170C, manufactured by NIPPON STEEL CHEMICAL & MATERIAL CO., LTD.) and 7 g of amine hardener (KARAHARD A-A, manufactured by Nippon Kayaku Co., Ltd.), and a resultant mixture was kneaded by hand. A hand-kneaded resin composition was pre-kneaded with use of a rotating and revolving mixer (Awatori Rentaro AR-500, manufactured by THINKY CORPORATION) (kneading: 1000 rpm, 8 minutes; defoaming: 2000 rpm, 2 minutes). A pre-kneaded resin composition was stored in a constant temperature water bath at 25° C. and then kneaded with use of a three roll mill (BR-150HCV, manufactured by AIMEX CO., LTD., roll diameter of φ63.5). The kneading was performed under the conditions that a kneading temperature was 25° C., a roll-to-roll distance was 20 μm, and the number of times of kneading was eight times. The resin composition thus obtained was defoamed for 30 minutes under reduced pressure with use of a vacuum pump (TSW-150 manufactured by SATO VAC INC.).

The kneaded resin composition was measured for initial viscosity (η₁) and viscosity after 1 day (η₂) at a shear rate of 1 s⁻¹ with use of a rheometer (HAAKE MARS40, manufactured by Thermo Fisher Scientific Inc.). Note that a measurement temperature was 25° C., and a sensor used was C35/1 (cone plate type; diameter of 35 mm; angle: 1 degree; material: titanium). Here, the resin composition was stored at 25° C.

Using the viscosity at the preparation of the resin composition (η₁) and the viscosity after 1 day (η₂), the rate of change in viscosity with time was calculated by the following formula.

Rate of change in viscosity with time [%]=((η₂−η₁)/η₁)×100

(12) Presence or Absence of Flow Mark at Gap Penetration

Two sheets of glass were stacked in advance with a gap of 30 μm provided therebetween. With the sheets of glass heated to 110° C., a high temperature penetration test was performed on the kneaded resin compositions prepared in (10) and (11) (at the preparation). The presence or absence of flow marks was evaluated by visual observation of the appearance.

(13) Production Conditions for Base Silica Powder

Production was carried out with use of a burner having a basic structure illustrated in a diagrammatic form in FIG. 1. However, depending on the experimental examples, the number of burners may be three. Hot water was circulated as the refrigerant. In addition to the aforementioned definitions, definitions under the production conditions shown in the tables are as below.

Oxygen Concentration

(Number of moles of oxygen introduced into the central pipe)/(Number of moles of oxygen introduced into the central pipe+Number of moles of nitrogen introduced into the central pipe)×100

RO

(Number of moles of oxygen introduced into the central pipe)/(16×Number of moles of raw material introduced into the central pipe)

R_{SFL}

(Number of moles of hydrogen introduced into the first annular pipe)/(32×Number of moles of raw material introduced into the central pipe)

Heat Removal Quantity

(Specific heat of hot water)×(Amount of hot water introduced)×(Hot water outlet temperature−Hot water inlet temperature)

Further, since hot water was introduced at 75° C. in all experimental examples, the hot water inlet temperature is 75° C. 1 kcal/kg was used as the specific heat of hot water. Note that the outlet and the inlet are a hot water discharge port and a hot water introduction port in the jacket portion (not illustrated).

Combustion Heat Quantity

(Number of moles of introduced raw material×Combustion heat quantity of raw material)+(Number of moles of introduced hydrogen×Combustion heat quantity of hydrogen)

1798 kcal/mol was used as the combustion heat quantity of a raw material (octamethylcyclotetrasiloxane), and 58 kcal/mol was used as the combustion heat quantity of hydrogen.

Table 1 will be discussed in which the central pipe, the first annular pipe, and the second annular pipe of the concentric triple pipe are described simply as the central canal, the first annular pipe, and the second annular pipe, respectively. Δ is a distance between the center of the central pipe and the center of another central pipe (a length of the side of the equilateral triangle), d is an inner diameter of the central pipe, and D is a shortest distance between the center of the central pipe and the inner wall of the reactor. When D/d is larger, it means a greater distance between a flame and the inner wall of the reactor.

### Production Example 1

Three concentric triple pipes of the same dimension were used as burners. These concentric triple pipes were arranged such that the centers of concentric triple pipes formed an equilateral triangle, and a tubular external cylinder was attached so as to surround the concentric triple pipes. The three burners were mounted such that the centers of the burners were located at the center of the reactor, and the experiment was carried out.

Under the above settings, octamethylcyclotetrasiloxane was burned as described below to produce base silica powder.

After a vaporized octamethylcyclotetrasiloxane, oxygen, and nitrogen were mixed, a resultant mixture was introduced into the central pipe of the concentric triple pipe at 200° C. Further, hydrogen and nitrogen were mixed, and a resultant mixture was introduced into the first annular pipe, which is the nearest outer peripheral pipe to the central pipe of the concentric triple pipe. Further, oxygen was introduced into the second annular pipe, which is the nearest outer peripheral pipe to the first annular pipe of the concentric triple pipe. In addition, air was introduced into a space defined by the outer wall of the second annular pipe of the concentric triple pipe and the inner wall of the external pipe surrounding the concentric triple pipe. Hot water was introduced into the jacket portion of the reactor at 75° C.

BET specific surface area, absorbance τ₄₆₀, absorbance τ₇₀₀, mass-based particle size distribution by centrifugal sedimentation method, loose bulk density, packed bulk density, Fe content, Ni content, Cr content, Al content, Na⁺ content, K⁺ content, and Cl⁻ content of the obtained base silica powder were measured. Further, the shape of the primary particles constituting the base silica powder was determined by electron microscope observation. From the absorbance τ₄₆₀ and the absorbance τ₇₀₀, the dispersibility index n was calculated. From the mass-based particle size distribution by the centrifugal sedimentation method, the median diameter D₅₀ and cumulative 90 mass % diameter D₉₀, and the geometric standard deviation σ_{g} were calculated.

Table 1 shows the production conditions and the properties of the obtained base silica powder. Further, the contents of Fe, Ni, Cr, Al, Na⁺, K⁺ and Cl⁻ were all less than 1 ppm.

### Production Examples 2 to 12

The production conditions were changed as shown in

Table 1, and base silica powder was produced in the same manner as in Production Example 1. Table 1 shows the physical properties of the obtained base silica powder. In all of Examples, the contents of Fe, Ni, Cr, Al, Na⁺, K⁺ and Cl⁻ were all less than 1 ppm.

TABLE 1

| | | | Production | Production | Production | Production | Production | Production |
|---|---|---|---|---|---|---|---|---|
| | | | Example 1 | Example 2 | Example 3 | Example 4 | Example 5 | Example 6 |
| Production | Number of | [Number] | 3 | 3 | 3 | 3 | 3 | 3 |
| conditions | concentric | | | | | | | |
| | triple pipes | | | | | | | |
| | Δ/d | [—] | 2.9 | 2.9 | 2.9 | 2.9 | 2.9 | 2.9 |
| | D/d | [—] | 11.4 | 11.4 | 11.4 | 8.1 | 8.1 | 8.1 |
| | Oxygen | [%] | 53 | 53 | 53 | 53 | 53 | 53 |
| | concentration | | | | | | | |
| | RO | [—] | 0.25 | 0.25 | 0.25 | 0.25 | 0.25 | 0.25 |
| | R_{SFL} | [—] | 0.22 | 0.15 | 0.15 | 0.15 | 0.15 | 0.15 |
| | R_{cmbts} | [—] | 0.82 | 0.82 | 0.82 | 0.82 | 0.82 | 0.82 |
| | N_{G3}/M_{Si} | [Nm³/kg] | 0.27 | 0.82 | 0.27 | 0.82 | 0.27 | 0.00 |
| | Heat removal | [%] | 60 | 52 | 56 | 36 | 46 | 51 |
| | quantity/ | | | | | | | |
| | combustion | | | | | | | |
| | heat quantity | | | | | | | |
| Physical | BET specific | [m²/g] | 8.7 | 10.5 | 10.7 | 11.8 | 10.4 | 9.9 |
| properties | surface area | | | | | | | |
| | T₄₆₀ | [—] | 1.06 | 1.00 | 0.95 | 0.92 | 1.04 | 1.05 |
| | T₇₀₀ | [—] | 0.41 | 0.37 | 0.36 | 0.34 | 0.39 | 0.40 |
| | n | [—] | 2.28 | 2.34 | 2.33 | 2.36 | 2.32 | 2.31 |
| | D₅₀ | [nm] | 384 | 360 | 357 | 336 | 367 | 377 |
| | D₉₀ | [nm] | 512 | 490 | 492 | 475 | 497 | 507 |
| | {(D₉₀ − D₅₀)/ | [%] | 33 | 36 | 38 | 41 | 35 | 35 |
| | D₅₀} × 100 | | | | | | | |
| | σ_{g} | [—] | 1.29 | 1.32 | 1.37 | 1.38 | 1.31 | 1.31 |
| | Shape of | [—] | Spherical | Spherical | Spherical | Spherical | Spherical | Spherical |
| | primary | | | | | | | |
| | particles | | | | | | | |
| | Loose bulk | [kg/m³] | 300 | 316 | 285 | 277 | 303 | 285 |
| | density | | | | | | | |
| | Packed bulk | [kg/m³] | 546 | 480 | 448 | 418 | 487 | 477 |
| | density | | | | | | | |

| | | | Production | Production | Production | Production | Production | Production |
|---|---|---|---|---|---|---|---|---|
| | | | Example 7 | Example 8 | Example 9 | Example 10 | Example 11 | Example 12 |
| Production | Number of | [Number] | 3 | 3 | 3 | 3 | 3 | 3 |
| conditions | concentric | | | | | | | |
| | triple pipes | | | | | | | |
| | Δ/d | [—] | 2.9 | 2.9 | 2.9 | 2.9 | 2.9 | 2.9 |
| | D/d | [—] | 8.1 | 8.1 | 8.1 | 8.1 | 8.1 | 8.1 |
| | Oxygen | [%] | 53 | 53 | 53 | 53 | 53 | 53 |
| | concentration | | | | | | | |
| | RO | [—] | 0.25 | 0.25 | 0.25 | 0.25 | 0.25 | 0.25 |
| | R_{SFL} | [—] | 0.14 | 0.12 | 0.22 | 0.26 | 0.26 | 0.37 |
| | R_{cmbts} | [—] | 0.83 | 0.83 | 0.82 | 0.82 | 0.92 | 0.82 |
| | N_{G3}/M_{Si} | [Nm³/kg] | 0.25 | 0.22 | 0.27 | 0.27 | 0.27 | 0.27 |
| | Heat removal | [%] | 43 | 39 | 50 | 49 | 48 | 46 |
| | quantity/ | | | | | | | |
| | combustion | | | | | | | |
| | heat quantity | | | | | | | |
| Physical | BET specific | [m²/g] | 10.1 | 10.1 | 9.4 | 9.3 | 9.5 | 9.4 |
| properties | surface area | | | | | | | |
| | T₄₆₀ | [—] | 1.03 | 1.00 | 1.10 | 1.10 | 1.09 | 1.06 |
| | T₇₀₀ | [—] | 0.39 | 0.38 | 0.43 | 0.43 | 0.42 | 0.41 |
| | n | [—] | 2.32 | 2.33 | 2.25 | 2.26 | 2.27 | 2.27 |
| | D₅₀ | [nm] | 367 | 364 | 395 | 397 | 388 | 393 |
| | D₉₀ | [nm] | 491 | 489 | 541 | 541 | 529 | 534 |
| | {(D₉₀ − D₅₀)/ | [%] | 34 | 34 | 37 | 36 | 36 | 36 |
| | D₅₀} × 100 | | | | | | | |
| | σ_{g} | [—] | 1.30 | 1.30 | 1.32 | 1.31 | 1.31 | 1.31 |
| | Shape of | [—] | Spherical | Spherical | Spherical | Spherical | Spherical | Spherical |
| | primary | | | | | | | |
| | particles | | | | | | | |
| | Loose bulk | [kg/m³] | 283 | 293 | 284 | 313 | 300 | 291 |
| | density | | | | | | | |
| | Packed bulk | [kg/m³] | 474 | 469 | 462 | 528 | 508 | 508 |
| | density | | | | | | | |

(14) Production of Surface-Treated Silica Powder

### Example 1

A rocking mixer (RM-30, manufactured by Aichi Electric

Co., Ltd.) was used as a mixer for surface treatment, and phenyltrimethoxysilane (KBM-103, manufactured by Shin-Etsu Silicones; 14.70 g; 25 μmol/g) serving as a surface treatment agent was fed at a rate of 2 mL/min with use of a peristaltic pump (SJ-1211 II-H, manufactured by ATTA), with respect to the base silica powder (2.97 kg) obtained in Production Example 1. After the temperature was increased from room temperature to 40° C. in 20 minutes while mixing was carried out, the temperature was maintained at 40° C. for 60 minutes. After that, the temperature was increased to 150° C. in 60 minutes, and was then maintained at 150° C. for 180 minutes. Aging and mixing were stopped, and cooling was carried out. As a result, surface-treated silica powder was obtained.

BET specific surface area, mass-based particle size distribution by a laser diffraction scattering method, surface carbon amount, Fe content, Ni content, Cr content, Al content, Na⁺ content, K⁺ content, and Cl⁻ content of the obtained surface-treated silica powder were measured. Further, the shape of the primary particles constituting the surface-treated silica powder was determined by electron microscope observation. From the mass-based particle size distribution by the laser diffraction scattering method, the median diameter D₅₀ and cumulative 90 mass % diameter D₉₀, and the geometric standard deviation σ_{g} were calculated.

Table 2 shows the properties of the surface-treated silica powder obtained in Example 1. Further, the contents of Fe, Ni, Cr, Al, Na⁺, K⁺ and Cl⁻ were all less than 1 ppm.

### Example 2

A rocking mixer (RM-30, manufactured by Aichi Electric Co., Ltd.) was used as a mixer for surface treatment, and hexamethyldisilazane (SZ-31, manufactured by Shin-Etsu Silicones; 16.76 g; 46.5 μmol/g) serving as a surface treatment agent was fed at a rate of 2.5 mL/min with use of a peristaltic pump (SJ-1211 II-H, manufactured by ATTA), with respect to the base silica powder (2.24 kg) obtained in Production Example 1. After the temperature was increased from room temperature to 150° C. in 60 minutes while mixing was carried out, the temperature was maintained at 150° C. for 120 minutes. After that, aging and mixing were stopped, and cooling was carried out. As a result, surface-treated silica powder was obtained.

BET specific surface area, mass-based particle size distribution by a laser diffraction scattering method, surface carbon amount, Fe content, Ni content, Cr content, Al content, Na⁺ content, K⁺ content, and Cl⁻ content of the obtained surface-treated silica powder were measured. Further, the shape of the primary particles constituting the surface-treated silica powder was determined by electron microscope observation. From the mass-based particle size distribution by the laser diffraction scattering method, the median diameter D50 and cumulative 90 mass % diameter D₉₀, and the geometric standard deviation σ_{g} were calculated.

Table 2 shows the properties of the surface-treated silica powder obtained in Example 2. Further, the contents of Fe, Ni, Cr, Al, Na⁺, K⁺ and Cl⁻ were all less than 1 ppm.

### Example 3

Into a 2-litter separable flask equipped with a stirring blade, 1014 g of water and 424 g of the base silica powder obtained in Production Example 1 were placed, and a mixture was stirred at 25° C. Phenyltrimethoxysilane (KBM-103, manufactured by Shin-Etsu Silicones; 5.0 g; 60 μmol/g) serving as a surface treatment agent was added to the mixture dropwise and mixed. The temperature was increased to 90° C., and stirring was carried out for 6 hours. After the stirring was finished, a dispersion liquid was cooled to 25° C. Then, a silica cake was collected by filtration under reduced pressure and dried at 120° C. under reduced pressure for 15 hours. As a result, 376 g of surface-treated silica powder was obtained.

BET specific surface area, mass-based particle size distribution by a laser diffraction scattering method, surface carbon amount, Fe content, Ni content, Cr content, Al content, Na⁺ content, K⁺ content, and Cl⁻ content of the obtained surface-treated silica powder were measured. Further, the shape of the primary particles constituting the surface-treated silica powder was determined by electron microscope observation. From the mass-based particle size distribution by the laser diffraction scattering method, the median diameter D50 and cumulative 90 mass % diameter D₉₀, and the geometric standard deviation σ_{g} were calculated.

Table 2 shows the properties of the surface-treated silica powder obtained in Example 3. Further, the contents of Fe, Ni, Cr, Al, Na⁺, K⁺ and Cl⁻ were all less than 1 ppm.

### Example 4

Into a 5-litter separable flask equipped with a stirring blade, 800 g of a 90% by mass aqueous methanol solution and 800 g of the base silica powder obtained in Production Example 1 were placed, and a mixture was stirred at 25° C. Hexamethyldisilazane (SZ-31, manufactured by Shin-Etsu Silicones; 240 g; 1.86 mmol/g) serving as a surface treatment agent was added to the mixture dropwise and mixed. The temperature was increased to 45° C., and stirring was carried out for 1 hour, so that silica particles were subjected to surface treatment. Further, 360 g of a 4% by mass aqueous ammonium hydrogen carbonate solution serving as a coagulant was added, and the mixture was stirred for 2 hours for aging. After the stirring was finished, a dispersion liquid was cooled to 25° C. Then, a silica cake was collected by filtration under reduced pressure and dried at 120° C. under reduced pressure for 15 hours. As a result, 760 g of surface-treated silica powder was obtained.

BET specific surface area, mass-based particle size distribution by a laser diffraction scattering method, surface carbon amount, Fe content, Ni content, Cr content, Al content, Na⁺ content, K⁺ content, and Cl⁻ content of the obtained surface-treated silica powder were measured. Further, the shape of the primary particles constituting the surface-treated silica powder was determined by electron microscope observation. From the mass-based particle size distribution by the laser diffraction scattering method, the median diameter D50 and cumulative 90 mass % diameter D₉₀, and the geometric standard deviation σ_{g} were calculated.

Table 2 shows the properties of the surface-treated silica powder obtained in Example 4. Further, the contents of Fe, Ni, Cr, Al, Na⁺, K⁺ and Cl⁻ were all less than 1 ppm.

### Example 5

A rocking mixer (RM-30, manufactured by Aichi Electric Co., Ltd.) was used as a mixer for surface treatment, and the base silica powder (3.00 kg) obtained in Production Example 1 and 3-glycidoxypropyltrimethoxysilane (KBM-403, manufactured by Shin-Etsu Silicones; 20.55 g; 29 μmol/g) serving as a surface treatment agent were fed at 25° C. at a rate of 2 mL/min with use of a peristaltic pump (SJ-1211 II-H, manufactured by ATTA). After that, the temperature was maintained at 25° C. for 120 minutes. Mixing was stopped, and the powder was collected and then aged at 25° C. for 14 days. After that, the powder was dried in vacuum at 50° C. overnight. As a result, surface-treated silica powder was obtained.

BET specific surface area, mass-based particle size distribution by a laser diffraction scattering method, surface carbon amount, Fe content, Ni content, Cr content, Al content, Na⁺ content, K⁺ content, and Cl⁻ content of the obtained surface-treated silica powder were measured. Further, the shape of the primary particles constituting the surface-treated silica powder was determined by electron microscope observation. From the mass-based particle size distribution by the laser diffraction scattering method, the median diameter D50 and cumulative 90 mass % diameter D₉₀, and the geometric standard deviation σ_{g} were calculated.

Table 2 shows the properties of the surface-treated silica powder obtained in Example 5. Further, the contents of Fe, Ni, Cr, Al, Na⁺, K⁺ and Cl⁻ were all less than 1 ppm.

### Example 6

Into a 2-litter separable flask equipped with a stirring blade, 1190 g of a 90% by mass aqueous methanol solution and 510 g of the base silica powder obtained in Production Example 1 were placed, and a mixture was stirred at 50° C. 3-glycidoxypropyltrimethoxysilane (KBM-403, manufactured by Shin-Etsu Silicones; 34.9 g; 0.29 mmol/g) serving as a surface treatment agent was added to the mixture dropwise and mixed. Stirring was carried out for 6 hours, so that silica particles were subjected to surface treatment. After the stirring was finished, a dispersion liquid was cooled to 25° C. Then, a silica cake was collected by centrifugal separation and dried at 50° C. under reduced pressure overnight. As a result, 510 g of surface-treated silica powder was obtained.

BET specific surface area, mass-based particle size distribution by a laser diffraction scattering method, surface carbon amount, Fe content, Ni content, Cr content, Al content, Na⁺ content, K⁺ content, and Cl⁻ content of the obtained surface-treated silica powder were measured. Further, the shape of the primary particles constituting the surface-treated silica powder was determined by electron microscope observation. From the mass-based particle size distribution by the laser diffraction scattering method, the median diameter D₅₀ and cumulative 90 mass % diameter D₉₀, and the geometric standard deviation σ_{g} were calculated.

Table 2 shows the properties of the surface-treated silica powder obtained in Example 6. Further, the contents of Fe, Ni, Cr, Al, Na⁺, K⁺ and Cl⁻ were all less than 1 ppm.

### Example 7

A rocking mixer (RM-30, manufactured by Aichi Electric Co., Ltd.) was used as a mixer for surface treatment, and the base silica powder (3.00 kg) obtained in Production Example 1 and N-phenyl-3-aminopropyltrimethoxysilane (KBM-573, manufactured by Shin-Etsu Silicones; 22.21 g; 29 μmol/g) serving as a surface treatment agent were fed at 25° C. at a rate of 2 mL/min with use of a peristaltic pump (SJ-1211 II-H, manufactured by ATTA). After that, the temperature was maintained at 25° C. for 120 minutes. Mixing was stopped, and the powder was collected and then aged at 25° C. for 14 days. After that, the powder was dried in vacuum at 50° C. overnight. As a result, surface-treated silica powder was obtained.

BET specific surface area, mass-based particle size distribution by a laser diffraction scattering method, surface carbon amount, Fe content, Ni content, Cr content, Al content, Na⁺ content, K⁺ content, and Cl⁻ content of the obtained surface-treated silica powder were measured. Further, the shape of the primary particles constituting the surface-treated silica powder was determined by electron microscope observation. From the mass-based particle size distribution by the laser diffraction scattering method, the median diameter D50 and cumulative 90 mass % diameter D₉₀, and the geometric standard deviation σ_{g} were calculated.

Table 2 shows the properties of the surface-treated silica powder obtained in Example 7. Further, the contents of Fe, Ni, Cr, Al, Na⁺, K⁺ and Cl⁻ were all less than 1 ppm.

### Example 8

A rocking mixer (RM-30, manufactured by Aichi Electric Co., Ltd.) was used as a mixer for surface treatment, and the base silica powder (3.00 kg) obtained in Production Example 1 and 3-methacryloxypropyltrimethoxysilane (KBM-503, manufactured by Shin-Etsu Silicones; 21.60 g; 29 μmol/g) serving as a surface treatment agent were fed at 25° C. at a rate of 2 mL/min with use of a peristaltic pump (SJ-1211 II-H, manufactured by ATTA). After that, the temperature was maintained at 25° C. for 120 minutes. Mixing was stopped, and the powder was collected and then aged at 25° C. for 14 days. After that, the powder was dried in vacuum at 50° C. overnight. As a result, surface-treated silica powder was obtained.

BET specific surface area, mass-based particle size distribution by a laser diffraction scattering method, surface carbon amount, Fe content, Ni content, Cr content, Al content, Na⁺ content, K⁺ content, and Cl⁻ content of the obtained surface-treated silica powder were measured. Further, the shape of the primary particles constituting the surface-treated silica powder was determined by electron microscope observation. From the mass-based particle size distribution by the laser diffraction scattering method, the median diameter D50 and cumulative 90 mass % diameter D₉₀, and the geometric standard deviation σ_{g} were calculated.

Table 2 shows the properties of the surface-treated silica powder obtained in Example 8. Further, the contents of Fe, Ni, Cr, Al, Na⁺, K⁺ and Cl⁻ were all less than 1 ppm.

### Example 9

A rocking mixer (RM-30, manufactured by Aichi Electric Co., Ltd.) was used as a mixer for surface treatment, and the base silica powder (3.00 kg) obtained in Production Example 1 and vinyltrimethoxysilane (KBM-1003, manufactured by Shin-Etsu Silicones; 12.90 g; 29 μmol/g) serving as a surface treatment agent were fed at 25° C. at a rate of 2 mL/min with use of a peristaltic pump (SJ-1211 II-H, manufactured by ATTA). After that, the temperature was maintained at 25° C. for 30 minutes. Mixing was stopped, and the powder was collected and then aged at 120° C. for 6 hours. After that, the powder was dried in vacuum at 25° C. overnight. As a result, surface-treated silica powder was obtained.

BET specific surface area, mass-based particle size distribution by a laser diffraction scattering method, surface carbon amount, Fe content, Ni content, Cr content, Al content, Na⁺ content, K⁺ content, and Cl⁻ content of the obtained surface-treated silica powder were measured. Further, the shape of the primary particles constituting the surface-treated silica powder was determined by electron microscope observation. From the mass-based particle size distribution by the laser diffraction scattering method, the median diameter D₅₀ and cumulative 90 mass % diameter D₉₀, and the geometric standard deviation σ_{g} were calculated.

Table 2 shows the properties of the surface-treated silica powder obtained in Example 9. Further, the contents of Fe, Ni, Cr, Al, Na⁺, K⁺ and Cl⁻ were all less than 1 ppm.

### Comparative Example 1

The silica obtained in Production Example 1 was used as base silica powder, without being subjected to surface treatment.

TABLE 2

| | | Example 1 | Example 2 | Example 3 | Example 4 | Example 5 |
|---|---|---|---|---|---|---|
| Specific surface area | [m²/g] | 9.0 | 7.4 | 10.1 | 7.1 | 8.4 |
| D₅₀ | [nm] | 359 | 357 | 358 | 357 | 362 |
| D₉₀ | [nm] | 465 | 458 | 462 | 458 | 466 |
| {(D₉₀ − D₅₀)/D₅₀} | [%] | 29.4 | 28.3 | 28.9 | 28.5 | 28.7 |
| σ_{g} | [—] | 1.23 | 1.22 | 1.23 | 1.22 | 1.22 |
| Peak at not less | [—] | Not detected | Not detected | Not detected | Not detected | Not detected |
| than 5 μm in | | | | | | |
| laser diffraction | | | | | | |
| scattering method | | | | | | |
| Shape of primary | [—] | Spherical | Spherical | Spherical | Spherical | Spherical |
| particles | | | | | | |
| Carbon amount | [wt %] | 0.176 | 0.110 | 0.365 | 0.115 | 0.241 |

| | | Example 6 | Example 7 | Example 8 | Example 9 |
|---|---|---|---|---|---|
| Specific surface area | [m²/g] | 8.0 | 8.6 | 8.9 | 8.9 |
| D₅₀ | [nm] | 358 | 365 | 362 | 362 |
| D₉₀ | [nm] | 461 | 472 | 468 | 468 |
| {(D₉₀ − D₅₀)/D₅₀} | [%] | 28.6 | 29.5 | 29.2 | 29.1 |
| σ_{g} | [—] | 1.22 | 1.23 | 1.23 | 1.22 |
| Peak at not less | [—] | Not detected | Not detected | Not detected | Not detected |
| than 5 μm in | | | | | |
| laser diffraction | | | | | |
| scattering method | | | | | |
| Shape of primary | [—] | Spherical | Spherical | Spherical | Spherical |
| particles | | | | | |
| Carbon amount | [wt %] | 0.225 | 0.328 | 0.268 | 0.080 |

(Evaluation of Dispersibility of Silica Powder Using Epoxy Resin)

In Examples 1 to 4, Examples 7 to 9, and Comparative Example 1, kneading with a resin was carried out, and viscosity measurement was then carried out. The results obtained by the viscosity measurement are summarized in Table 3.

TABLE 3

| | | | | | | | | | Comparative |
|---|---|---|---|---|---|---|---|---|---|
| | | Example 1 | Example 2 | Example 3 | Example 4 | Example 7 | Example 8 | Example 9 | Example 1 |
| Viscosity at 25° C. | [Pa · s] | 38.2 | 503.1 | 24.1 | 638.3 | 26.5 | 396.7 | 282.5 | 1415.5 |
| Viscosity at 25° C. | [Pa · s] | 45.0 | 547.8 | 19.8 | 650.6 | 69.6 | 312.2 | 343.4 | 937.2 |
| after 1 week | | | | | | | | | |
| Rate of change in | [%] | 17.8 | 8.9 | −17.8 | 1.9 | 162.6 | −21.3 | 21.6 | −33.8 |
| viscosity with time | | | | | | | | | |
| Viscosity at 110° C. | [Pa · s] | 1.7 | 40.0 | 0.6 | 31.3 | 2.3 | 14.5 | 8.0 | 12.1 |
| Viscosity at 110° C. | [Pa · s] | 1.4 | 36.4 | 0.5 | 21.9 | 4.4 | 11.0 | 4.7 | 10.4 |
| after 1 week | | | | | | | | | |
| Rate of change in | [%] | −17.6 | −9.0 | −16.7 | −30.0 | 91.3 | −24.1 | −41.3 | −14.0 |
| viscosity with time | | | | | | | | | |

(Evaluation of Dispersibility of Silica Powder Using Thermosetting Resin)

In Example 1, Examples 5 to 7, and Comparative Example 1, kneading with a resin was carried out, and viscosity measurement was then carried out. The results obtained by the viscosity measurement are summarized in Table 4.

TABLE 4

| | | | | | | Comparative |
|---|---|---|---|---|---|---|
| | | Example 1 | Example 5 | Example 6 | Example 7 | Example 1 |
| Viscosity at 25° C. | [Pa · s] | 24.9 | 17.6 | 18.5 | 19.4 | 1115.1 |
| Viscosity at 25° C. | [Pa · s] | 2105.6 | 31.6 | 26.5 | 27.8 | Unmeasurable |
| after 1 day | | | | | | |
| Rate of change in | [%] | 8356.2 | 79.5 | 43.2 | 43.3 | — |
| viscosity with time | | | | | | |

(Presence or Absence of Flow Mark at Gap Penetration)

No significant flow marks were observed in any of Examples 1 to 9 and Comparative Example 1.

### REFERENCE SIGNS LIST

1 burner
2 tubular external cylinder
3 reactor

1. A method for producing surface-treated silica powder, the method including bringing silica powder into contact with a surface treatment agent, the silica powder satisfying all of the following conditions (1) to (3):
(1) a cumulative 50 mass % diameter D₅₀ of a mass-based particle size distribution obtained by a centrifugal sedimentation method is not less than 300 nm and not more than 500 nm;
(2) a loose bulk density is not less than 250 kg/m³ and not more than 400 kg/m³; and
(3) {(D₉₀−D₅₀)/D₅₀}×100 is not less than 30% and not more than 45%, wherein D₉₀ is a cumulative 90 mass % diameter of the mass-based particle size distribution obtained by the centrifugal sedimentation method.

2. The method according to claim 1, wherein the silica powder is such that a geometric standard deviation σ_{g} of the mass-based particle size distribution obtained by the centrifugal sedimentation method is in a range of not less than 1.25 and not more than 1.40.

3. The method according to claim 1, wherein the silica powder is such that element contents of iron, nickel, chromium, and aluminum are each less than 1 ppm.

4. The method according to claim 1, wherein the silica powder is such that ion contents of sodium ions, potassium ions, and chloride ions which are measured by a hot water extraction method are each less than 1 ppm.

5. The method according to claim 1, wherein the surface treatment agent is at least one selected from the group consisting of a silane coupling agent and silazanes.

6. The method according to claim 5, wherein the silane coupling agent is a compound represented by the following formula (1):
Rₙ—Si—X₍₄₋ₙ₎ (1)
(In the formula (1), R is an organic group having 1 to 12 carbon atoms, X is a hydrolyzable group, and n is an integer of 1 to 3.).

7. The method according to claim 5, wherein the silazanes are alkyl silazanes.

8. A resin composition in which surface-treated silica powder produced by the method according to claim 1 is dispersed in a resin.

9. A slurry including surface-treated silica powder produced by the method according to claim 1 and a dispersion medium in liquid form.
